(19) United States
(12) Patent Application Publication
(10) Pub. No.: US 2025/0261289 A1
(43) Pub. Date: Aug. 14, 2025

(54) INDUCTION COIL ASSEMBLY

(71) Applicant: WHIRLPOOL CORPORATION, BENTON HARBOR, MI (US)

(72) Inventors: Mario Barbati, Comerio (IT); Andrea Gallivanoni, Casorate Sempione (IT); Salvatore Baldo, VARESE (IT)

(73) Assignee: WHIRLPOOL CORPORATION, BENTON HARBOR, MI (US)

(21) Appl. No.: 18/437,874

(22) Filed: Feb. 9, 2024

(51) Int. Cl. H05B 6/12; H05B 6/06; H05B 6/44

(52) U.S. Cl. CPC H05B 6/1281; H05B 6/062; H05B 6/44

(57) ABSTRACT

An induction cooktop includes a cooking surface operable to support cookware and a resonant circuit having a resonant frequency in the range of 40 kHz to 60 kHz. The resonant circuit includes a capacitor having capacitance of between 0.1 micro-Farads and 0.6 micro-Farads and a coil disposed under the cooking surface and configured to operate at a working frequency of between 50 kHz and 150 kHz. The induction cooktop includes an induction control circuit configured to power the resonant circuit at the working frequency.

### FIELD OF THE DISCLOSURE

The disclosure generally relates to an induction coil assembly and, more particularly, to a heater coil with enhanced efficiency for operation with a full-bridge inverter.

### SUMMARY OF THE DISCLOSURE

According to one aspect of the present disclosure, an induction cooktop includes a cooking surface operable to support cookware and a resonant circuit having a resonant frequency in the range of 40 kHz to 60 kHz. The resonant circuit includes a capacitor having capacitance of between 0.1 micro-Farads and 0.6 micro-Farads and a coil disposed under the cooking surface and configured to operate at a working frequency of between 50 kHz and 150 kHz. The induction cooktop includes an induction control circuit configured to power the resonant circuit at the working frequency.

According to another aspect of the present disclosure, an induction coil assembly for an induction cooktop includes a cooking surface operable to support cookware and a resonant circuit having a resonant frequency in the range of 40 kHz to 60 kHz. The resonant circuit includes a capacitor having capacitance of between 0.1 uF and 0.6 uF and a coil disposed under the cooking surface and configured to operate at a working frequency of between 50 kHz and 150 kHz. An induction control circuit is configured to power the resonant circuit at the working frequency via a full-bridge inverter.

According to yet another aspect of the present disclosure, an induction cooktop includes a cooking surface operable to support cookware and a resonant circuit having a resonant frequency in the range of 40 kHz to 60 kHz. The resonant circuit includes a capacitor having capacitance of between 0.1 micro-Farads and 0.6 micro-Farads and a coil disposed under the cooking surface and configured to operate at a working frequency of between 50 kHz and 150 kHz. The resonant circuit is configured to have an equivalent alternating-current (AC) resistance of between 8 ohms and 15 ohms at the working frequency when cookware overlays the coil and includes a bottom made of AISI 430. An induction control circuit is configured to power the resonant circuit at the working frequency via a full-bridge inverter.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of a cooktop incorporating one or more induction coil assemblies according to one aspect of the present disclosure;

FIG. 2 is an electrical schematic of an induction heating circuit for an induction coil assembly constructed according to at least one aspect of the present disclosure;

FIG. 3 is an exploded perspective view of a first induction coil assembly;

FIG. 4 is a top plan view of the first induction coil assembly;

FIG. 5 is a top plan view of a top heat-resistant layer for the first induction coil assembly;

FIG. 6 is a side view of the top heat-resistant layer for the first induction coil assembly;

FIG. 7 is a top plan view of a coil of the first induction coil assembly;

FIG. 8 is a side view of the coil of the first induction coil assembly;

FIG. 9 is a cross-sectional view of the coil of the first induction coil assembly taken along the line X-X of FIG. 7;

FIG. 10 is a top plan view of a ferrite layer of the first induction coil assembly;

FIG. 11 is a side view of the ferrite layer of the first induction coil assembly;

FIG. 12 is a cross-sectional view of the first induction coil assembly taken along the line XII-XII of FIG. 4;

FIG. 13 is a detailed view of a portion of the cross-sectional view of FIG. 12 taken along the section XIII-XIII of FIG. 12;

FIG. 14 is an exploded perspective view of a second induction coil assembly;

FIG. 15 is a top plan view of the second induction coil assembly;

FIG. 16 is a top plan view of a top heat-resistant layer for the second induction coil assembly;

FIG. 17 is a side view of the top heat-resistant layer for the second induction coil assembly;

FIG. 18 is a top plan view of a coil of the second induction coil assembly;

FIG. 19 is a side view of the coil of the second induction coil assembly;

FIG. 20 is a cross-sectional view of the coil of the second induction coil assembly taken along the line XX-XX of FIG. 18;

FIG. 21 is a top plan view of a ferrite layer of the second induction coil assembly;

FIG. 22 is a side view of the ferrite layer of the second induction coil assembly;

FIG. 23 is a cross-sectional view of the second induction coil assembly taken along the line XXIII-XXIII of FIG. 15;

FIG. 24 is a detailed view of a portion of the cross-sectional view of FIG. 23 taken along the section XXIV-XXIV of FIG. 23;

FIG. 25 is an exploded perspective view of a third induction coil assembly;

FIG. 26 is a top plan view of the third induction coil assembly;

FIG. 27 is a top plan view of a top heat-resistant layer for the third induction coil assembly;

FIG. 28 is a side view of the top heat-resistant layer for the third induction coil assembly;

FIG. 29 is a top plan view of a coil of the third induction coil assembly;

FIG. 30 is a side view of the coil of the third induction coil assembly;

FIG. 31 is a cross-sectional view of the coil of the third induction coil assembly taken along the line XXXI-XXXI of FIG. 29;

FIG. 32 is a top plan view of a ferrite layer of the third induction coil assembly;

FIG. 33 is a side view of the ferrite layer of the third induction coil assembly;

FIG. 34 is a cross-sectional view of the third induction coil assembly taken along the line XXXIV-XXXIV of FIG. 26;

FIG. 35 is a detailed view of a portion of the cross-sectional view of FIG. 23 taken along the section XXXV-XXXV FIG. 34;

FIG. 36 is an exploded perspective view of a fourth induction coil assembly;

FIG. 37 is a top plan view of the fourth induction coil assembly;

FIG. 38 is a top plan view of a top heat-resistant layer for the fourth induction coil assembly;

FIG. 39 is a side view of the top heat-resistant layer for the fourth induction coil assembly;

FIG. 40 is a top plan view of a coil of the fourth induction coil assembly;

FIG. 41 is a side view of the coil of the fourth induction coil assembly;

FIG. 42 is a cross-sectional view of the coil of the fourth induction coil assembly taken along the line XLII-XLII of FIG. 40;

FIG. 43 is a top plan view of a ferrite layer of the fourth induction coil assembly;

FIG. 44 is a side view of the ferrite layer of the fourth induction coil assembly;

FIG. 45 is a cross-sectional view of the fourth induction coil assembly taken along the line XLV-XLV of FIG. 37;

FIG. 46 is a detailed view of a portion of the cross-sectional view of FIG. 45 taken along the section XLVI-XLVI of FIG. 45;

FIG. 47 is an exploded perspective view of a fifth induction coil assembly;

FIG. 48 is a top plan view of the fifth induction coil assembly;

FIG. 49 is a top plan view of a top heat-resistant layer for the fifth induction coil assembly;

FIG. 50 is a side view of the top heat-resistant layer for the fifth induction coil assembly;

FIG. 51 is a top plan view of a coil of the fifth induction coil assembly;

FIG. 52 is a cross-sectional view of the coil of the fifth induction coil assembly taken along the line LII-LII of FIG. 50;

FIG. 53 is a top plan view of a ferrite layer of the fifth induction coil assembly;

FIG. 54 is a first side view of the ferrite layer of the fifth induction coil assembly;

FIG. 55 is a second side view of the ferrite layer of the fifth induction coil assembly;

FIG. 56 is a cross-sectional view of the fifth induction coil assembly taken along the line LVI-LVI of FIG. 48;

FIG. 57 is a detailed view of a portion of the cross-sectional view of FIG. 23 taken along the section LVII-LVII of FIG. 56; and

FIG. 58 is a table of parameters for 5 exemplary coil assemblies constructed according to aspects of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to an induction coil assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

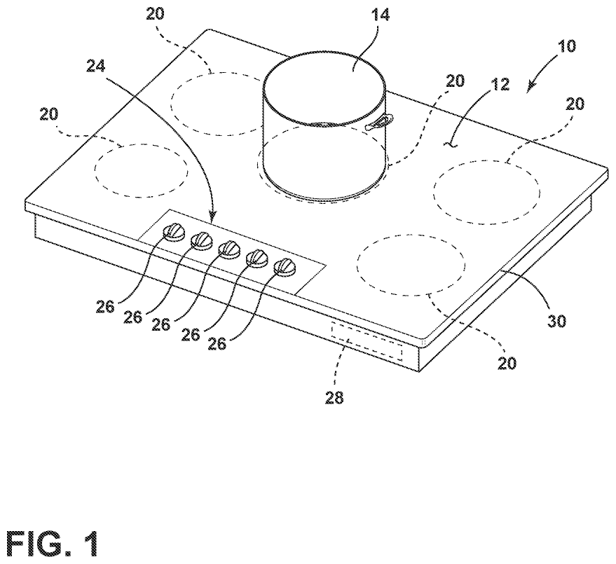

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

In general, the present induction coil assembly provides a slim design that may be cost-effective. The present induction coils assembly further provides for enhanced electrical efficiencies by being configured to operate, in some examples, via a full bridge connection. The present induction coil assembly provides for increased resistance relative to traditional induction coils and a unique arrangement of a ferrite layer to provide for optimized induction heating.

Referring generally to the figures, numeral 10 generally designates an induction cooktop. The induction cooktop 10 includes a cooking surface 12 operable to Support cookware 14. A resonant circuit 16 has a resonant frequency in the range of 40 kHz to 60 kHz. The resonant circuit 16 includes a capacitor 18 having a capacitance of between 0.1 microfarads and 0.6 microfarads. The resonant circuit 16 includes an induction heater coil 20 disposed under the cooking surface 12. The induction heater coil 20 is configured to operate at a working frequency of between 50 kHz and 150 kHz. The induction cooktop 10 includes an induction control circuit configured to power the resonant circuit 16 at the working frequency.

Referring now to FIG. 1, the induction cooktop 10 may include an induction hob and can include a control interface 24 which may include mechanical switches 26 and/or touch interfaces for controlling the induction cooktop 10. For example, a controller 28 may be provided within the induction cooktop assembly for controlling power to one or more of the induction heater coils 20 of the induction cooktop 10. A glass layer 30, or insulating layer, may form the cooking surface 12 and provide space between the induction heater coils 20 in the induction cooktop and the cooking surface 12. As will be described further herein, the glass layer 30 can have a glass height 31 of between 2.5 millimeters and 5 millimeters. In some examples, the glass height 31 is approximately 4 millimeters. It is contemplated that, while shown in FIG. 1 as having a circular shape, one or more of the induction heater coils 20 may have another polygonal or arcuate shape, such as a square, rectangle, a triangle, or the like. It is also contemplated that irregular polygonal shapes or partial rectangular shapes (e.g., rectangles with arcuate corners) may be provided. Accordingly, the cooktop 10 may incorporate one or more of differently shaped induction heater coils 20, as will be described further herein. Further, the spacing and/or pattern of distribution of the induction heater coils 20 for the induction cooktop may be different than pictured or the same as pictured. For example, the induction heater coils 20 may be arranged side to side or front to back to provide a free-form induction cooking area throughout the entire cooking surface 12 or a substantial part of the cooking surface 12. Further, different sizes of the induction heater coil 20 may be provided.

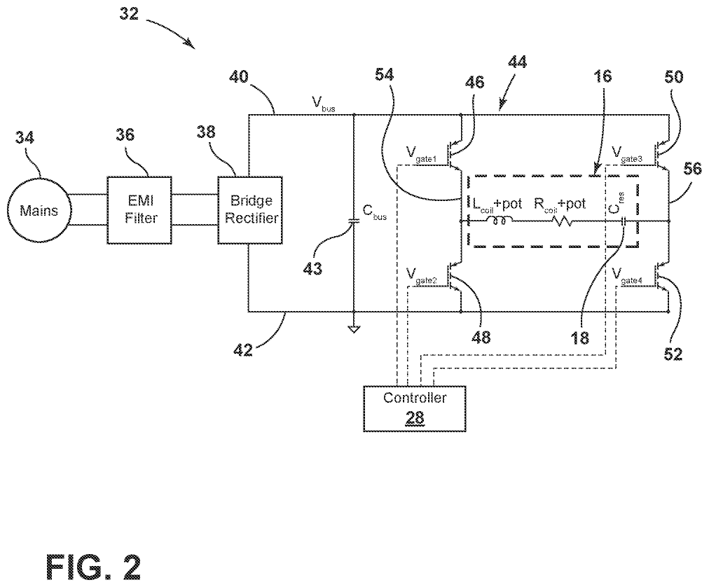

Referring now to FIG. 2, a heating circuit 32 is provided in reference to one exemplary induction heater coil 20, though, as will be described herein, the heating circuit 32 may be configured to power some or all of the induction heater coils 20 of the induction cooktop. The heating surface may be powered via main power 34, which may be an alternating-current (AC) voltage. For example, the main power 34 may include 110 VAC/115 VAC, 120 VAC, 230 VAC/240 VAC with a frequency of 50 Hz/60 Hz, or another AC signal typically provided for residential or commercial power distribution. An electromagnetic interference (EMI) filter 36 is provided for reducing electromagnetic interference generated during high-frequency operation of the induction cooktop. This filter typically includes capacitors, and inductors arranged to suppress unwanted electromagnetic radiation.

Filtered power is provided to a rectifier 38 that converts alternating current power to direct current (DC) power provided along a DC bus 40 and a ground 42. For example, the rectifier 38 can include one or more diodes arranged to isolate positive parts of the AC power, and one or more smoothing capacitors 43 to smooth the DC power. One or more inverters 44 are provided between the DC bus 40 and ground 42 for generating controlled AC signals through one or more of the induction heater coils 20. In the present example, a full bridge inverter 44 is provided for controlling each induction heater coil 20, though it is contemplated that other types of inverters 44 (half bridge inverters 44) may be provided in some examples described herein. In a preferred embodiment, a full-bridge inverter 44 is used to allow for operation at higher effective AC voltages relative to those used for a half-bridge, thereby allowing for reduced operating currents for the same power levels.

In general, each inverter 44 includes switches 46, 48, 50, 52, such as transistors, that are controlled by the controller 28 to close and/or open paths for current to flow through the resonant circuit 16. In the full bridge example, the resonant circuit 16 is provided between two intermediate nodes 54, 56 that are electrically coupled to a pair of corresponding switches 46, 48, 50, 52. The two intermediate nodes 54, 56 include a first intermediate node 54 that electrically interposes a first switch and a second switch 46, 48 and a second intermediate node 56 that interposes a third switch and a fourth switch 50, 52. The resonant circuit 16 electrically interposes the pair of intermediate nodes 54, 56. In operation, the controller 28 energizes the first switch and the fourth switch 46, 52 at a first time, then de-energizes the first switch and the fourth switch 46, 52, then energizes the second switch and the third switch 48, 50, then de-energizes the second switch and the third switch 48, 50, and so on. In this way, the inverter 44 is controlled to provide an effective AC voltage across the resonant circuit 16 to generate magnetic fields through the insulating layer of the cooktop 10. For example, when alternating currents pass through the induction heater coil 20, a magnetic field is generated. When cookware 14 is over the induction heater coils 20, the induced magnetic fields can cause Eddy currents in the cookware 14 thereby heating the cookware 14.

In addition to the induction heater coil 20, the resonant circuit 16 further includes the resonant capacitor 18, which can have a capacitance of between 0.1 microfarads and 0.6 microfarads. The capacitance of the resonant capacitor 18 allows for the present induction heater coils 20 to be constructed with relatively high resistance and/or a thinner, or shallower profile, as will be described in the foregoing examples. The resonant capacitor 18 further provides for the range of resonant frequencies (e.g., 40 kHz to 60 kHz) and the working frequency in the range of 50 kHz and 150 kHz. It is contemplated that these operable ranges may be provided in a full bridge configuration of the inverter 44.

With continued reference to FIG. 2, it is contemplated that the resonant circuit 16 described herein may be dependent on the type of cookware 14 (e.g., material, size, shape, etc.). For example, the representation of the resonant circuit 16 may include resistance when the cookware 14 is provided. By way of example, the cookware 14 may include stainless steel in a bottom portion of the cookware 14 (e.g., a floor of a pan or a pot). In one example, AISI-430 (American Iron and Steel Institute grade 430) is used in the floor of the cookware 14. AISI 430 is a grade of stainless steel that is part of the AISI (American Iron and Steel Institute) steel grades. It falls under the ferritic stainless steel category, which is characterized by a high chromium content and low carbon content. The AISI 430 stainless steel has strong corrosion resistance, formability, and heat resistance. For example, AISI 430 can contain between 16 and 18% Chromium, low Carbon, and a remainder of iron. AISI 430 is generally magnetic.

According to some examples, the resonant circuit 16 for the induction heater coil 20 is configured to have an equivalent AC resistance of between 8 and 15 ohms at the working frequency when the cookware 14 overlays the induction heater coil 20 and the bottom portion is made of AISI 430. The inductance of the induction heater coil 20 may be between 45 micro-Henries (uH) and 60 uH when the equivalent resistance is between 8 and 15 ohms at the working frequency. Other ranges of resistance, capacitance, and/or inductance may be achieved according to various examples described herein.

In general, the dimensions, parameters, values (e.g., electrical values), and the like described above and below are exemplary and non-limiting. For example, use of the term “approximately” may refer to +/−10% or +/−20% of a listed value, or target value. Use of the term “substantially” may refer to +/−5% or less of a listed value, or target value. By way of example, if an exemplary width is provided as about 9.9 millimeters, it is contemplated that such width may be in the range of 8.9 to 10.9 millimeters. Alternatively, the width may be in the range of 7.9 to 11.9 millimeters. Further, such dimension may be approximated by the value of 10 millimeters.

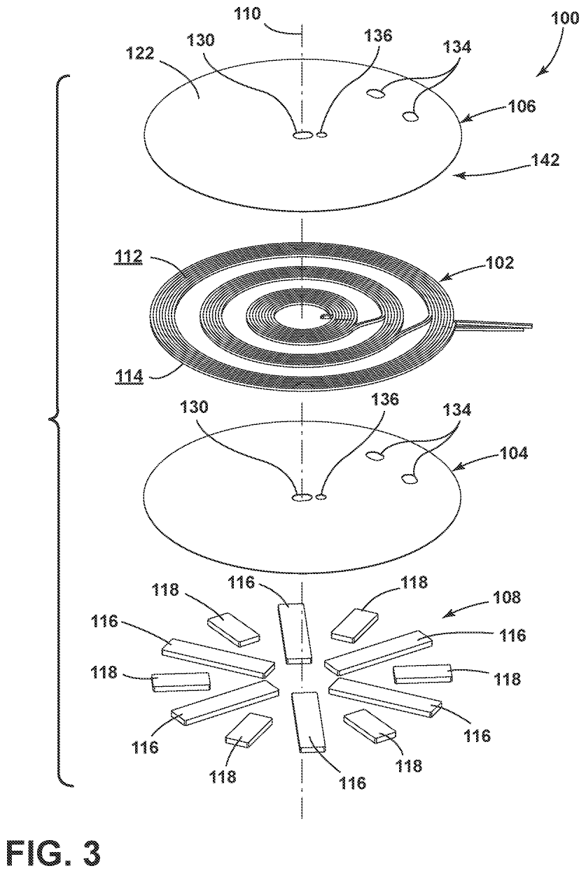

Referring now to FIGS. 3-13, a first induction coil assembly 100 is configured for operation with the heating circuit 32 of the present cooktop 10.

Referring more particularly to FIG. 3, the induction coil assembly 100 includes a coil 102, a pair of thermally resistant layers 104, 106, and a ferrite layer 108 each disposed on a central axis 110. The coil includes an upper side 112 and a lower side 114. The pair of thermally resistant layers 104, 106 engage the lower side 114 and the upper side 112, respectively. For example, the pair of thermally resistant layers 104, 106 can include a first layer 104 that engages the lower side 114 of the coil and a second layer 106 that engages the upper side 112 of the coil 102. In this way, the pair of thermally resistant layers 104, 106 sandwich, or pancake, the coil 102. The ferrite layer 108 is disposed under the first thermally resistant layer 104 and includes a plurality of ferrites 116, 118. The coil 102, the pair of thermally resistant layers 104, 106, and the ferrite layer 108 are stacked together to form the induction coil assembly 100, with the ferrite layer 108 defining a bottom surface 120 of the stack 100 and the second thermally resistant layer 106 forming a top surface 122 of the stack 100. An assembly height 124 is defined between the bottom surface 120 and the top surface 122 measured in a direction orthogonal to the cooking surface 12, the top surface 122, and/or the bottom surface 120.

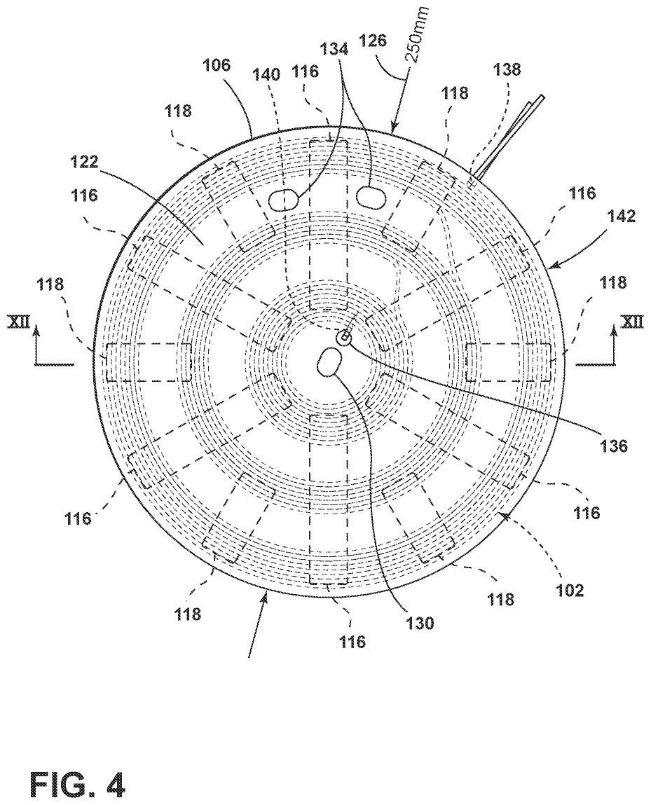

Referring now to FIG. 4, the pair of thermally resistant layers 104, 106 will be described in reference to the second thermally resistant layer 106, as the first thermally resistant layer 104 is substantially structurally similar to the first thermally resistant layer 104. Each of the pair of thermally resistant layers 104, 106 has a plate width 126 of 250 millimeters. As demonstrated, the pair of thermally resistant layers 104, 106 can define a stack width of the assembly, as the pair of thermally resistant layers 104, 106 can overhang the coil 102 and form the outermost points of the stack 100. Stated differently, the widest part of the stack 100 may be the pair of thermally resistant layers 104, 106.

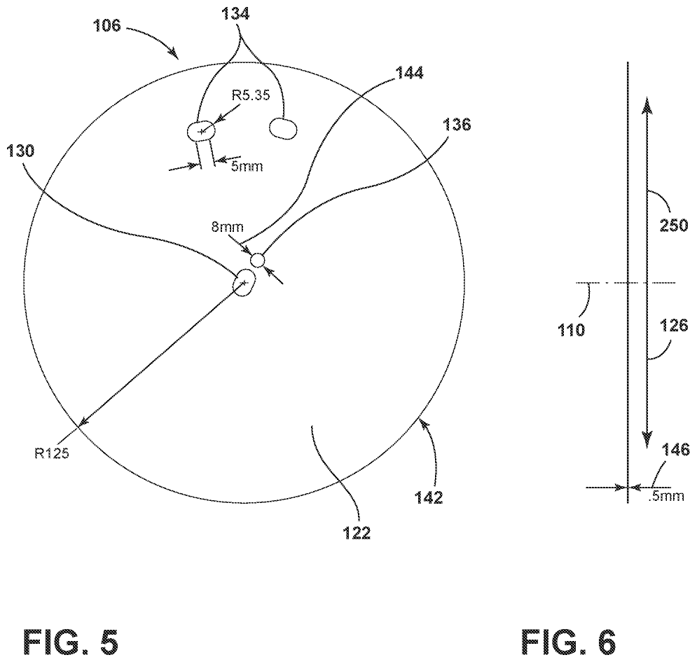

Referring now to FIGS. 5 and 6, the second layer 106, which may be structurally similar or identical to the first layer 104, defines a central slot 130 aligned with the central axis 110. The central slot 130 is configured to receive a temperature sensor and may have a stadium shape having radii of curvature of 5.35 millimeters and having a straight length of 5 millimeters. Each of the pair of thermally resistant layers 104, 106 may define one or more peripheral slots 134 spaced radially outwardly from the central slot 130.

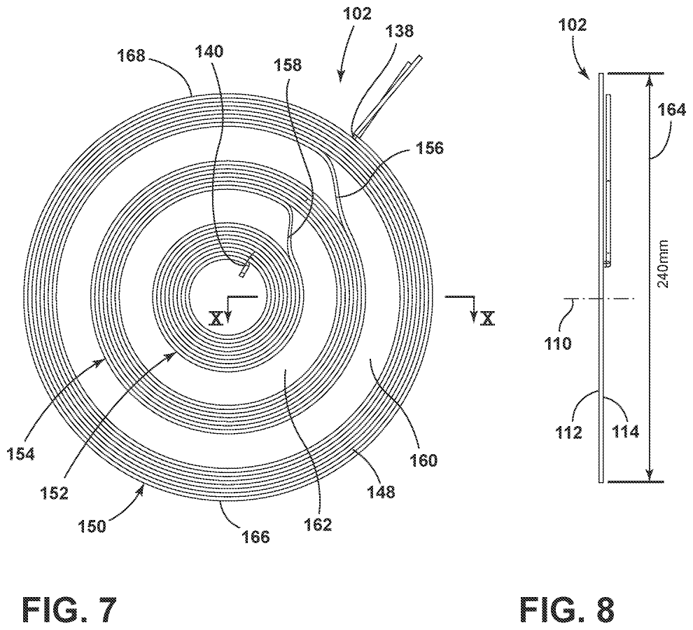

The second layer 106 further defines a passthrough hole 136 disposed adjacent to the central slot 130. The passthrough hole 136 is configured to receive a portion of the coil 102, such that when the stack 100 is assembled, two coil ends 138, 140 of the coil 102 (FIG. 7) may be accessed along an edge 142 of the stack 100. For example, the passthrough hole 136 can have a hole diameter 144 of 8 millimeters, which may be large enough to allow wire 148 of the coil 102 to pass through the second layer 106.

One or more of the thermally resistant layers 104, 106 has a plate height 146 of 0.5 millimeters. It is contemplated that the thermally resistant layers 104, 106 may be comprised of mica, such as mica sheeting. In some examples, the thermally resistant layers 104, 106 are made from muscovite or phlogopite mica. The thermally resistant layers 104, 106 may also be electrically insulative to limit current from arcing between adjacent turns of the coil 102. The thermally resistant layers 104, 106 may comprise magnesium, potassium, aluminum, and/or silica. The thermally resistant layers 104, 106 may include magnesium, aluminum, and silica. The thermally resistant layers 104, 106 may also, or alternatively, provide for mechanical stability to support the turns of the induction coil 102 to maintain the shape of the coil 102 and limit deformation. It is contemplated that the second layer 106 may be omitted in some examples, such that the top surface 122 of the stack 100 may be formed by the upper side 112 of the coil 102.

Referring now to FIGS. 7-9, the coil 102 includes wire 148 that forms an outer portion 150, an inner portion 152 spaced from the outer portion 150, and an intermediate portion 154 of the coil 102 spaced from and between the outer portion 150 and the inner portion 152. The wire 148 may be formed of Litz wire having individually insulated strands. The strands may be twisted or braided together forming windings, or turns, of the coil 102. In general, the wire 148 may provide for limited skin effect and proximity effect at high frequencies (e.g., the working frequency). For example, due to the skin effect, the flow of electric current tends to concentrate near the surface of a conductor. Litz wire may counteract this effect by providing the multiple insulated strands to distribute the current more evenly across a wire cross-sectional area.

The coil 102 includes a first coil end 138 and a second coil end 140. The first coil end 138 is disposed radially outwardly relative to the second coil end 140. The first coil end 138 may be coupled with the heating circuit 32 via connection between the pair of thermally resistant layers 104, 106 along the edge 142 of the stack 100, and the second coil end 140 may be coupled with the heating circuit 32 via access through the passthrough hole 136. For example, the wire 148 may pass through the passthrough hole 136 and extend radially outwardly toward the edge 142 of the stack 100 along the bottom side of the stack 100.

The portions of the coil 102 are connected with one another via interconnecting portions 156, 158 of the coil 102 that span coil gaps 160, 162. For example, an outer interconnecting portion 156 spans an outer coil gap 160 to connect the outer portion 150 and the intermediate portion 154 together, and an inner interconnecting portion 158 spans an inner coil gap 162 to connect the intermediate portion 154 and the inner portion 152 together. It is contemplated that, while the coil ends 138, 140 and the interconnecting portions 156, 158 are substantially aligned along a common radius of the coil 102, in some examples, the interconnecting portions 156, 158 are circumferentially spaced, or offset, from one or both of the coil ends 138, 140.

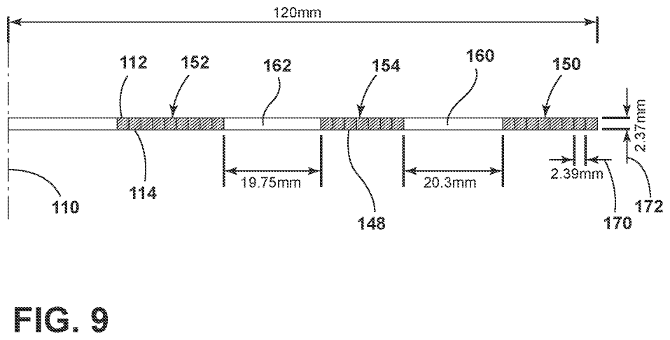

With particular reference to FIGS. 8 and 9, the coil 102 defines a coil width 164 of about 240 millimeters measured in a front-most part 166 to rear-most part 168 of the coil 102. The wire 148 has a wire width 170 of 2.39 millimeters. Accordingly, the pair of thermally resistant layers 104, 106 may overhang, or extend, radially past the coil 102 by about 5 millimeters, depending on the radial position of the coil 102.

The wire 148 may have a substantially square-shaped cross-section. For example, the wire 148 has a wire height 172 equivalent to the coil height of 2.37 millimeters. The cross-sectional area is 5.66 square millimeters. The outer portion 150 has 8 windings. The inner portion 152 has 9 windings. The intermediate portion 154 has 7 windings. The coil 102 has an inductance of 45 microhenries and a resistance of 8 ohms. The outer coil gap 160 is 20.3 millimeters. The inner coil gap 162 is 19.75 millimeters. Accordingly, the outer portion 150 is spaced from the inner portion 152 by 56.15 millimeters.

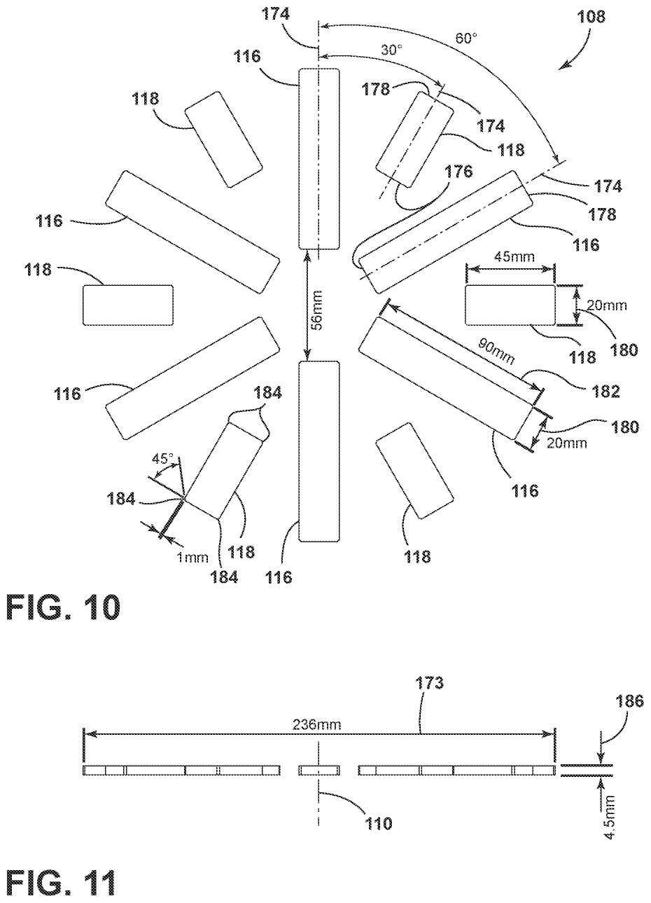

Referring now to FIGS. 10 and 11, the ferrite layer 108 includes ferrite material that may be a ceramic material with magnetic properties to direct the magnetic field generated by the coil 102. The ferrite layer 108 includes ceramic compounds that may include iron oxide combined with other metal oxides, such as zinc, nickel, and/or manganese to provide high magnetic permeability and low electrical conductivity. For example, the ferrite layer 108 includes a plurality of ferrites 116, 118 distributed in the ferrite layer 108 for shaping and focusing the magnetic fields produced by the coil 102, as well as the magnetic flux of the magnetic fields. The ferrites 116, 118 may be distributed evenly or unevenly. For example, the ferrites 116, 118 can be radially distributed evenly, while the individual shapes, lengths, and/or other dimensions of the ferrites 116, 118 may differ. In general, the ferrites 116, 118 may be rod- or bar-shaped to concentrate the magnetic field along the axis of the rod. This shape may be effective for creating a strong and focused magnetic field in a specific direction (e.g., radially inward or radially outwardly relative to the central axis 110).

The ferrite layer 108 has a ferrite layer width 173 of 236 millimeters. The plurality of ferrites 116, 118 includes a set of inner ferrites 116 and a set of outer ferrites 118, with the set of inner ferrites 116 extending more proximate to the central axis 110 relative to the set of outer ferrites 118. The set of inner ferrites 116 includes 6 ferrites 116 extending radially and evenly distributed about the central axis 110. The set of outer ferrites 118 also includes 6 ferrites extending radially and evenly distributed about the central axis 110. Accordingly, each of the set of inner ferrites 116 extends along an extension axis 174 central to each of the set of inner ferrites 116 that is 60 degrees offset from its adjacent inner ferrites 116, thereby forming a hexagonal distribution of the inner ferrites 116. Each inner ferrite 116 is radially spaced from the central axis 110 by about 28 millimeters at the extension axis 174. For example, each ferrite 116, 118 has a ferrite central end 176 and a ferrite peripheral end 178. The ferrite central end 176 of the inner ferrite 116 is spaced from the central axis 110 by about 28 millimeters at the extension axis 174. Each of the ferrites 116, 118 has a ferrite width 180 of 20 millimeters. The inner ferrites 116 have a ferrite length 182 of 90 millimeters. Further, each of the inner ferrites 116 and the outer ferrites 118 has 4 filleted vertices 184 each having legs (e.g., of a right triangle) equal to 1 millimeter. The inner ferrites 116 have a ferrite height 186 of 4.5 mm. Accordingly, each ferrite 116, 118 is substantially bar-shaped.

The set of outer ferrites 118 has the same ferrite width 180 as the set of inner ferrites 116 (e.g., 20 millimeters) and half of the ferrite length 182 of the outer ferrites 118 (e.g., 45 millimeters). The outer ferrites 118 are distributed in the same way as the distribution of the inner ferrites 116 but offset by 30 degrees relative to the distribution of the inner ferrites 116. The ferrite peripheral end 178 of each of the inner ferrites 116 and the outer ferrites 118 are spaced from the central axis 110 by 118 millimeters at the extension axis 174. The outer ferrites 118 similarly form rod-shaped bodies, and together, the inner and outer ferrites 116, 118 form a star-shaped distribution of the ferrite layer 108.

A circular area of the coil 102 (e.g., the area of the coil 102 parallel to the cooking surface 12 on one side of the coil 102) can influence the magnetic field strength and distribution generated by the coil 102. Further, the percentage of the circular area, or footprint, of the coil 102 covered by (or not covered by) the ferrite layer 108 can influence the distribution and flux of the magnetic field. Accordingly, the ferrite layer 108 may be sized, in terms of target area, volume, or the like, to provide enhanced magnetic field guidance. For example, the circular area of the coil 102 may be between 40,000 and 50,000 square millimeters. In the present example, the circular area of the coil 102 is about 45,000 square millimeters, and the target area (e.g., footprint area) of the ferrite layer 108 may be about 16,000 square millimeters. The target area of the ferrite layer 108 may be between 12,000 square millimeters and 20,000 square millimeters. Accordingly, the ferrite layer 108 may cover about 33% of the circular area of the coil 102. In this way, the magnetic fields may be focused directly to the cookware 14.

The distribution of the ferrite layer 108 enhances magnetic flux of the magnetic field by providing multiple sources relatively evenly distributed about the central axis 110. The enhanced magnetic properties provided by the ferrite layer 108, coupled with the ferrite layer width 173, provide for slim yet efficient functionality of the induction coil assembly 100.

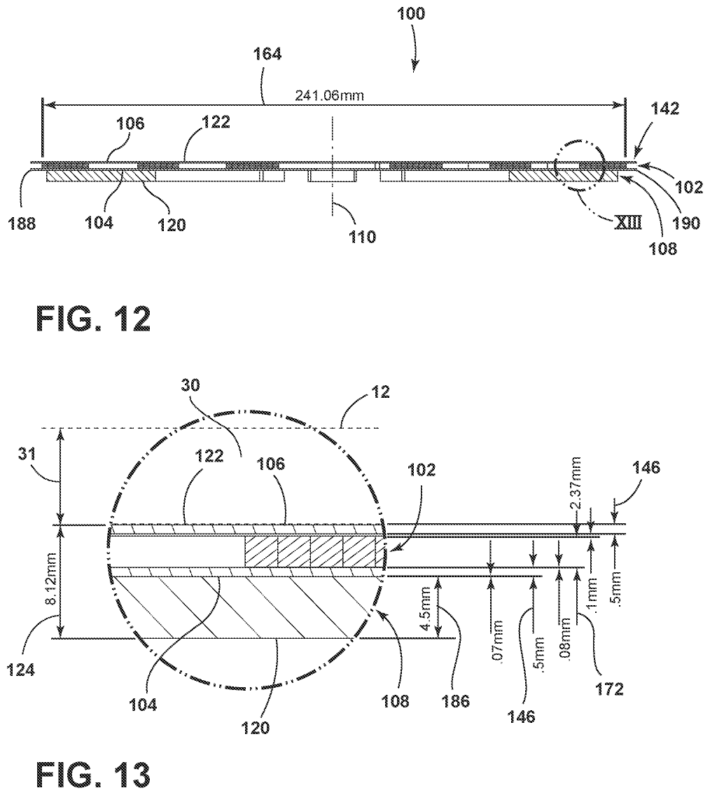

Referring now to FIGS. 12 and 13, the coil 102 has a cross-sectional width of 241.06 millimeters measured between a left-most part 188 to right-most part 190 of the coil 102. The stack 100 has an assembly height 124 of 8.12 millimeters, which is comprised of each plate height 146 (0.5 millimeters×2), the coil height 172 of 2.37 millimeters, and the ferrite height 186 of 4.5 millimeters. It is contemplated that stack 100 may maintain room for minor expansion or retraction (e.g., tolerance) of the components of the stack 100 that amount to about 0.25 millimeters. The top surface 122 of the stack 100 can be spaced from the cooking surface 12 by between 2.5 millimeters and 7 millimeters.

While specific parameters of the first induction coil assembly 100 are shown and described, it is contemplated that these parameters may differ without deviating from the aspects of the first induction coil assembly 100. For example, ratios, percentages, or proportions may differ. For example, the spacings between the outer portion 150, the inner portion 152, and the intermediate portions 154, as a ratio to the number of windings, may be similar in a first induction coil assembly 100 that is bigger or smaller than the example shown and described. For example, the various dimensional values and/or electrical values may be in the range of +/−10-20% of the listed value.

In general, the short stack height 124 of the first induction coil assembly 100 provides for enhanced space saving within the induction cooktop 10. By incorporating the full-bridge circuit in combination with a higher-resistance coil 102 and distribution of ferrites of the ferrite layer 108, a lower-cost dynamic solution may be provided.

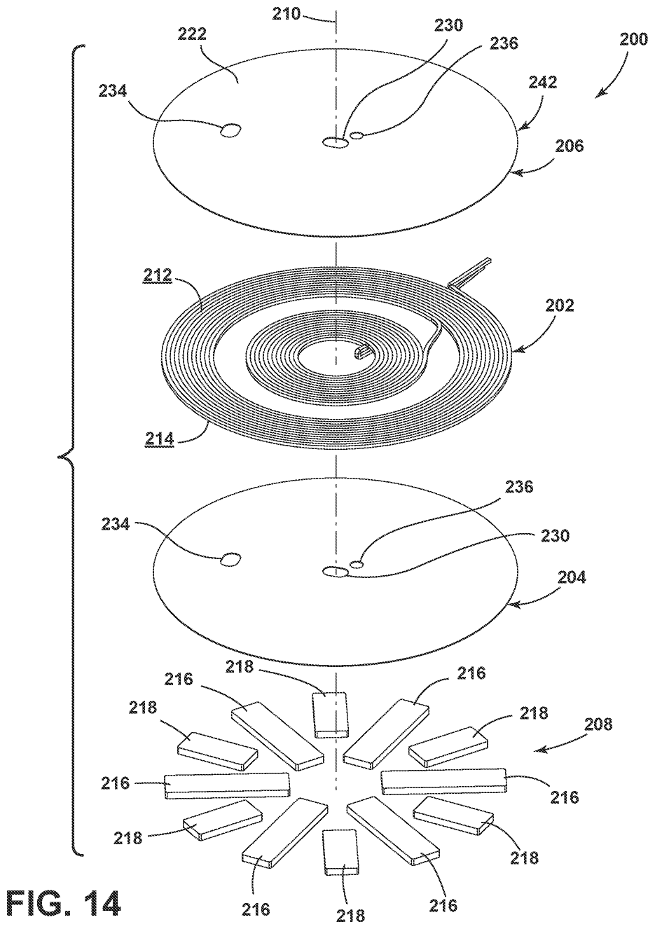

Referring now to FIGS. 14-24, a second induction coil assembly 200 is configured for operation with the heating circuit 32 of the present cooktop 10.

Referring more particularly to FIG. 14, the induction coil assembly 200 includes a coil 202, a pair of thermally resistant layers 204, 206, and a ferrite layer 208 each disposed on a central axis 210. The coil includes an upper side 212 and a lower side 214. The pair of thermally resistant layers 204, 206 engage the lower side 214 and the upper side 212, respectively. For example, the pair of thermally resistant layers 204, 206 can include a first layer 204 that engages the lower side 214 of the coil and a second layer 206 that engages the upper side 212 of the coil 202. In this way, the pair of thermally resistant layers 204, 206 sandwich, or pancake, the coil 202. The ferrite layer 208 is disposed under the first thermally resistant layer 204 and includes a plurality of ferrites 216, 218. The coil 202, the pair of thermally resistant layers 204, 206, and the ferrite layer 208 are stacked together to form the induction coil assembly 200, with the ferrite layer 208 defining a bottom surface 220 of the stack 200 and the second thermally resistant layer 206 forming a top surface 222 of the stack 200. An assembly height 224 is defined between the bottom surface 220 and the top surface 222 measured in a direction orthogonal to the cooking surface 12, the top surface 222, and/or the bottom surface 220.

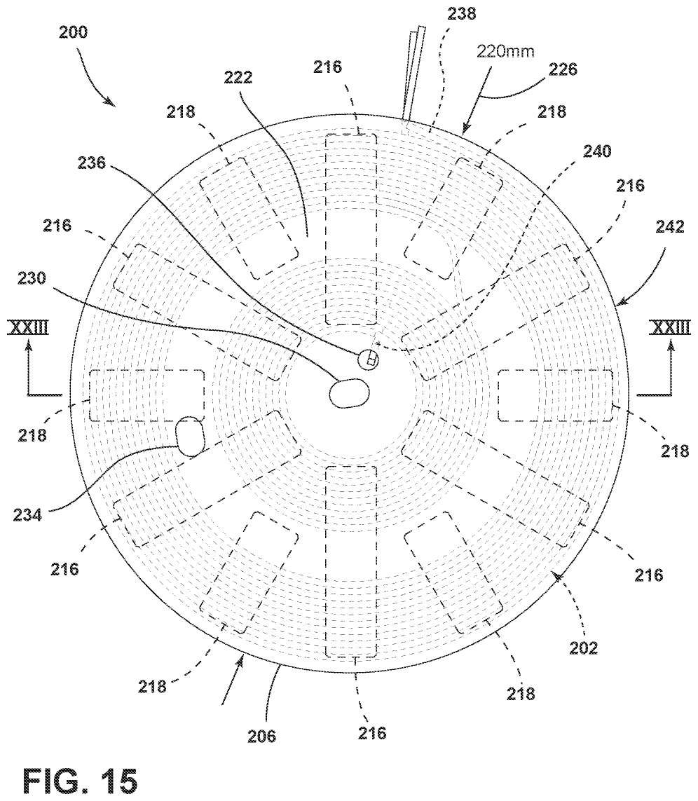

Referring now to FIG. 15, the pair of thermally resistant layers 204, 206 will be described in reference to the second thermally resistant layer 206, as the first thermally resistant layer 204 is substantially structurally similar to the first thermally resistant layer 204. Each of the pair of thermally resistant layers 204, 206 has a plate width 226 of 220 millimeters. As demonstrated, the pair of thermally resistant layers 204, 206 can define a stack width of the assembly, as the pair of thermally resistant layers 204, 206 can overhang the coil 202 and form the outermost points of the stack 200. Stated differently, the widest part of the stack 200 may be the pair of thermally resistant layers 204, 206.

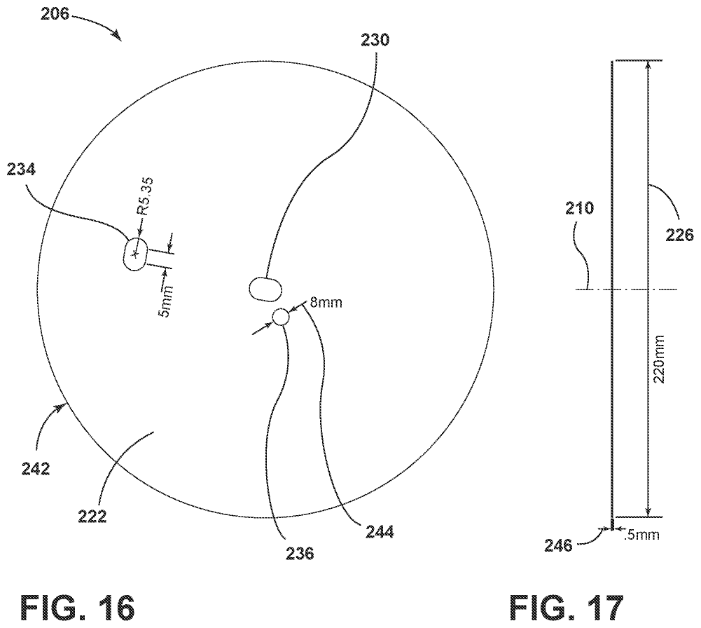

Referring now to FIGS. 16 and 17, the second layer 206, which may be structurally similar or identical to the first layer 204, defines a central slot 230 aligned with the central axis 210. The central slot 230 is configured to receive a temperature sensor and may have a stadium shape having radii of curvature of 5.35 millimeters and having a straight length of 5 millimeters. Each of the pair of thermally resistant layers 204, 206 may define one or more peripheral slots 234 spaced radially outwardly from the central slot 230.

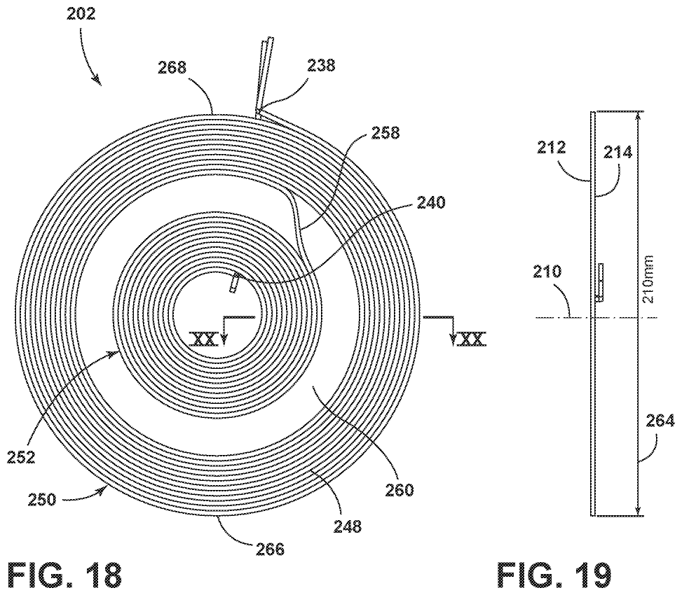

The second layer 206 further defines a passthrough hole 236 disposed adjacent to the central slot 230. The passthrough hole 236 is configured to receive a portion of the coil 202, such that when the stack 200 is assembled, two coil ends 238, 240 of the coil 202 (FIG. 18) may be accessed along an edge 242 of the stack 200. For example, the passthrough hole 236 can have a hole diameter 244 of 8 millimeters, which may be large enough to allow wire 248 of the coil 202 to pass through the second layer 206.

One or more of the thermally resistant layers 204, 206 has a plate height 246 of 0.5 millimeters. It is contemplated that the thermally resistant layers 204, 206 may be comprised of mica, such as mica sheeting. In some examples, the thermally resistant layers 204, 206 are made from muscovite or phlogopite mica. The thermally resistant layers 204, 206 may also be electrically insulative to limit current from arcing between adjacent turns of the coil 202. The thermally resistant layers 204, 206 may comprise magnesium, potassium, aluminum, and/or silica. The thermally resistant layers 204, 206 may include magnesium, aluminum, and silica. The thermally resistant layers 204, 206 may also, or alternatively, provide for mechanical stability to support the turns of the induction coil 202 to maintain the shape of the coil 202 and limit deformation. It is contemplated that the second layer 206 may be omitted in some examples, such that the top surface 222 of the stack 200 may be formed by the upper side 212 of the coil 202.

Referring now to FIGS. 18-20, the coil 202 includes wire 248 that forms an outer portion 250 and an inner portion 252 spaced from the outer portion 250. The wire 248 may be formed of Litz wire having individually insulated strands. The strands may be twisted or braided together forming windings, or turns, of the coil 202. In general, the wire 248 may provide for limited skin effect and proximity effect at high frequencies (e.g., the working frequency). For example, due to the skin effect, the flow of electric current tends to concentrate near the surface of a conductor. Litz wire may counteract this effect by providing the multiple insulated strands to distribute the current more evenly across a wire cross-sectional area.

The coil 202 includes a first coil end 238 and a second coil end 240. The first coil end 238 is disposed radially outwardly relative to the second coil end 240. The first coil end 238 may be coupled with the heating circuit 32 via connection between the pair of thermally resistant layers 204, 206 along the edge 242 of the stack 200, and the second coil end 240 may be coupled with the heating circuit 32 via access through the passthrough hole 236. For example, the wire 248 may pass through the passthrough hole 236 and extend radially outwardly toward the edge 242 of the stack 200 along the bottom side of the stack 200.

The portions 250, 252 of the coil 202 are connected with one another via an interconnecting portions 258 of the coil 202 that span outer coil gap 260. For example, the interconnecting portion 258 spans the outer coil gap 260 to connect the outer portion 250 and the inner portion 252 together. It is contemplated that, while the coil ends 238, 240 and the interconnecting portion 258 may be substantially aligned along a common radius of the coil 202, in some examples, the interconnecting portion 258 may be circumferentially spaced, or offset, from one or both of the coil ends 238, 240.

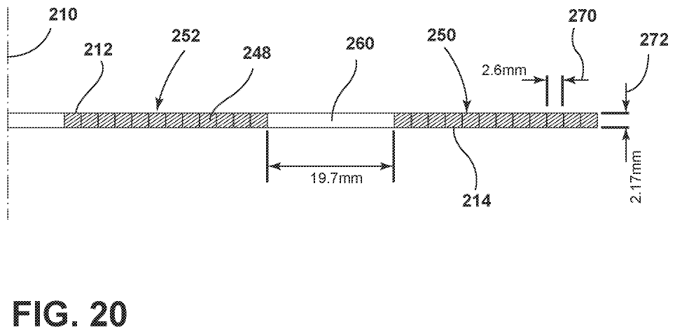

With particular reference to FIGS. 19 and 20, the coil 202 defines a coil width 264 of about 210 millimeters measured in a front-most part 266 to rear-most part 268 of the coil 202. The wire 248 has a wire width 270 of 2.6 millimeters. Accordingly, the pair of thermally resistant layers 204, 206 may overhang, or extend, radially past the coil 202 by about 5 millimeters, depending on the radial position of the coil 202.

The wire 248 may have a substantially square-shaped cross-section. For example, the wire 248 has a wire height 272 equivalent to the coil height of 2.17 millimeters. The cross-sectional area is 5.64 square millimeters. The outer portion 250 has 12 windings. The inner portion 252 has 12 windings. The coil 202 has an inductance of 50 microhenries and a resistance of 9 ohms. The outer coil gap 260 is 19.7 millimeters.

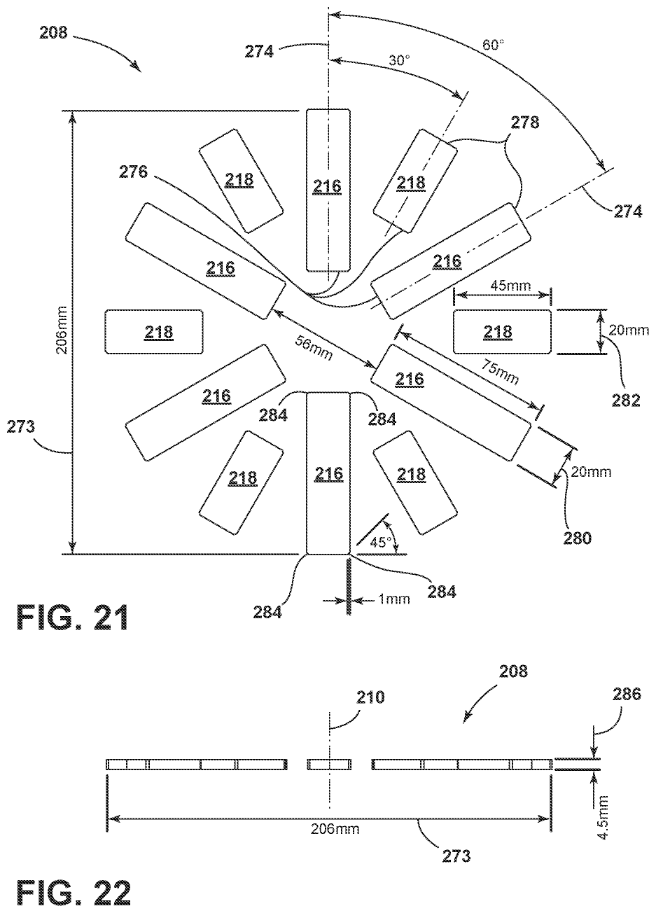

Referring now to FIGS. 21 and 22, the ferrite layer 208 includes ferrite material that may be a ceramic material with magnetic properties to direct the magnetic field generated by the coil 202. The ferrite layer 208 includes ceramic compounds that may include iron oxide combined with other metal oxides, such as zinc, nickel, and/or manganese to provide high magnetic permeability and low electrical conductivity. For example, the ferrite layer 208 includes a plurality of ferrites 216, 218 distributed in the ferrite layer 208 for shaping and focusing the magnetic fields produced by the coil 202, as well as the magnetic flux of the magnetic fields. The ferrites 216, 218 may be distributed evenly or unevenly. For example, the ferrites 216, 218 can be radially distributed evenly, while the individual shapes, lengths, and/or other dimensions of the ferrites 216, 218 may differ. In general, the ferrites 216, 218 may be rod- or bar-shaped to concentrate the magnetic field along the axis of the rod. This shape may be effective for creating a strong and focused magnetic field in a specific direction (e.g., radially inward or radially outwardly relative to the central axis 210).

The ferrite layer 208 has a ferrite layer width 273 of 206 millimeters. The plurality of ferrites 216, 218 includes a set of inner ferrites 216 and a set of outer ferrites 218, with the set of inner ferrites 216 extending more proximate to the central axis 210 relative to the set of outer ferrites 218. The set of inner ferrites 216 includes 6 ferrites 216 extending radially and evenly distributed about the central axis 210. The set of outer ferrites 218 also includes 6 ferrites extending radially and evenly distributed about the central axis 210. Accordingly, each of the set of inner ferrites 216 extends along an extension axis 274 central to each of the set of inner ferrites 216 that is 60 degrees offset from its adjacent inner ferrites 216, thereby forming a hexagonal distribution of the inner ferrites 216. Each inner ferrite 216 is radially spaced from the central axis 210 by about 28 millimeters at the extension axis 274. For example, each ferrite 216, 218 has a ferrite central end 276 and a ferrite peripheral end 278. The ferrite central end 276 of the inner ferrite 216 is spaced from the central axis 210 by about 28 millimeters at the extension axis 274. Each of the ferrites 216, 218 has a ferrite width 280 of 20 millimeters. The inner ferrites 216 have a ferrite length 282 of 75 millimeters. Further, each of the inner ferrites 216 and the outer ferrites 218 has 4 filleted vertices 284 each having legs (e.g., of a right triangle) equal to 1 millimeter. The inner ferrites 216 have a ferrite height 286 of 4.5 mm. Accordingly, each ferrite 216, 218 is substantially bar-shaped.

The set of outer ferrites 218 has the same ferrite width 280 as the set of inner ferrites 216 (e.g., 20 millimeters) and 60% of the ferrite length 282 of the outer ferrites 218 (e.g., 45 millimeters). The outer ferrites 218 are distributed in the same way as the distribution of the inner ferrites 216 but offset by 30 degrees relative to the distribution of the inner ferrites 216. The ferrite peripheral end 278 of each of the inner ferrites 216 and the outer ferrites 218 are spaced from the central axis 210 by 103 millimeters at the extension axis 274. The outer ferrites 218 similarly form rod-shaped bodies, and together, the inner and outer ferrites 216, 218 form a star-shaped distribution of the ferrite layer 208.

A circular area of the coil 202 (e.g., the area of the coil 202 parallel to the cooking surface 12 on one side of the coil 202) can influence the magnetic field strength and distribution generated by the coil 202. Further, the percentage of the circular area, or footprint, of the coil 202 covered by (or not covered by) the ferrite layer 208 can influence the distribution and flux of the magnetic field. Accordingly, the ferrite layer 208 may be sized, in terms of target area, volume, or the like, to provide enhanced magnetic field guidance. For example, the circular area of the coil 202 may be between 30,000 and 40,000 square millimeters. In the present example, the circular area of the coil 202 is about 35,000 square millimeters, and the target area (e.g., footprint area) of the ferrite layer 208 may be about 14,000-15,000 square millimeters. The target area of the ferrite layer 208 may be between 11,500 square millimeters and 17,500 square millimeters. Accordingly, the ferrite layer 208 may cover between 35% and 45% of the circular area of the coil 202. In this way, the magnetic fields may be focused directly to the cookware 14.

The distribution of the ferrite layer 208 enhances magnetic flux of the magnetic field by providing multiple sources relatively evenly distributed about the central axis 210. The enhanced magnetic properties provided by the ferrite layer 208, coupled with the ferrite layer width 273, provide for slim yet efficient functionality of the induction coil assembly 200.

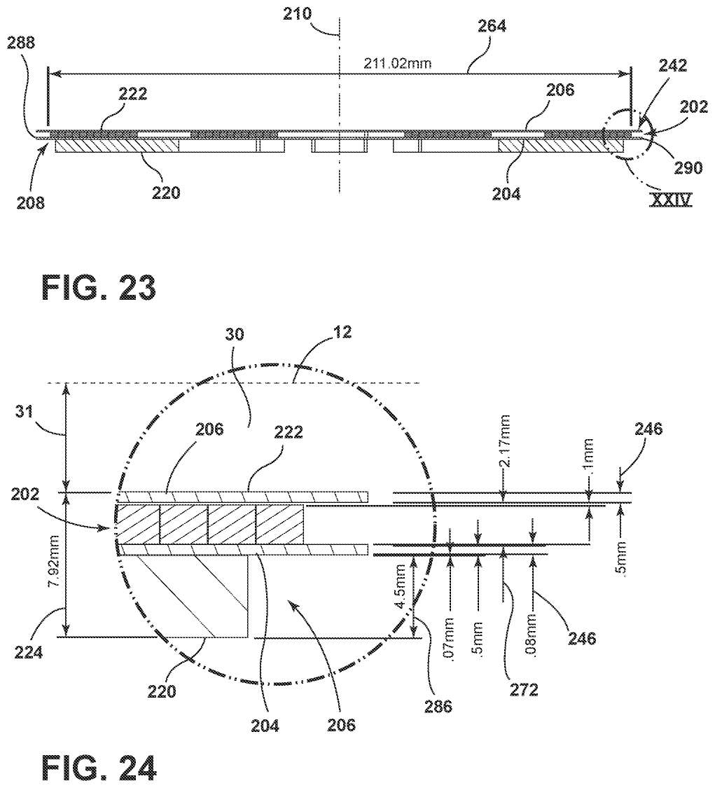

Referring now to FIGS. 23 and 24, the coil 202 has a cross-sectional width of 211.02 millimeters measured between a left-most part 288 to right-most part 290 of the coil 202. The stack 200 has an assembly height 224 of 7.92 millimeters, which is comprised of each plate height 246 (0.5 millimeters×2), the coil height 272 of 2.17 millimeters, and the ferrite height 286 of 4.5 millimeters. It is contemplated that stack 200 may maintain room for minor expansion or retraction (e.g., tolerance) of the components of the stack 200 that amount to about 0.25 millimeters. The top surface 222 of the stack 200 can be spaced from the cooking surface 12 by between 2.5 millimeters and 7 millimeters.

While specific parameters of the second induction coil assembly 200 are shown and described, it is contemplated that these parameters may differ without deviating from the aspects of the second induction coil assembly 200. For example, ratios, percentages, or proportions may differ. For example, the spacing between the outer portion 250 and the inner portion 252, as a ratio to the number of windings, may be similar in a second induction coil assembly 200 that is bigger or smaller than the example shown and described. For example, the various dimensional values and/or electrical values may be in the range of +/−10-20% of the listed value.

In general, the short stack height 224 of the second induction coil assembly 200 provides for enhanced space saving within the induction cooktop 10. By incorporating the full-bridge circuit in combination with a higher-resistance coil 202 and distribution of ferrites of the ferrite layer 208, a lower-cost dynamic solution may be provided.

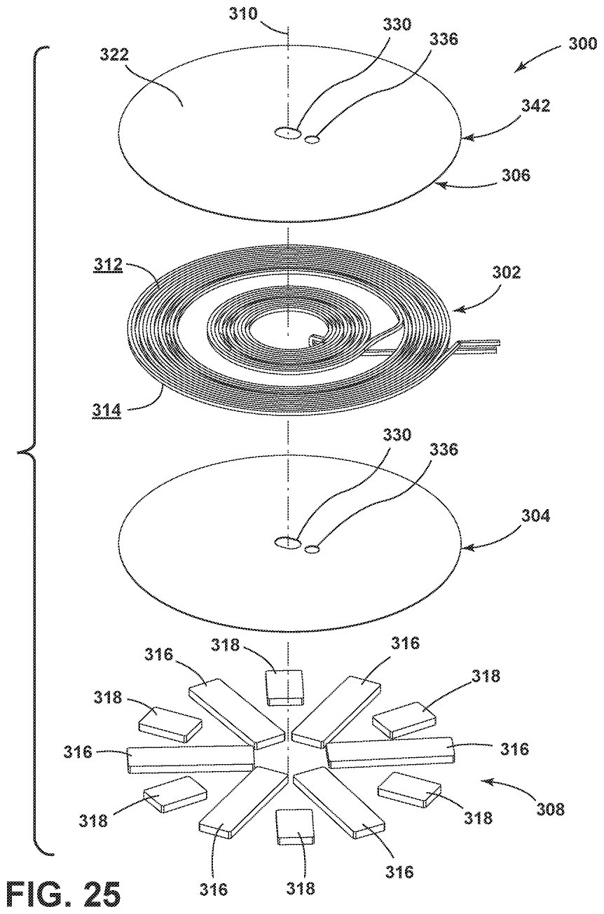

Referring now to FIGS. 25-35, a third induction coil assembly 300 is configured for operation with the heating circuit 32 of the present cooktop 10.

Referring more particularly to FIG. 25, the induction coil assembly 300 includes a coil 302, a pair of thermally resistant layers 304, 306, and a ferrite layer 308 each disposed on a central axis 310. The coil includes an upper side 312 and a lower side 314. The pair of thermally resistant layers 304, 306 engage the lower side 314 and the upper side 312, respectively. For example, the pair of thermally resistant layers 304, 306 can include a first layer 304 that engages the lower side 314 of the coil and a second layer 306 that engages the upper side 312 of the coil 302. In this way, the pair of thermally resistant layers 304, 306 sandwich, or pancake, the coil 302. The ferrite layer 308 is disposed under the first thermally resistant layer 304 and includes a plurality of ferrites 316, 318. The coil 302, the pair of thermally resistant layers 304, 306, and the ferrite layer 308 are stacked together to form the induction coil assembly 300, with the ferrite layer 308 defining a bottom surface 320 of the stack 300 and the second thermally resistant layer 306 forming a top surface 322 of the stack 300. An assembly height 324 is defined between the bottom surface 320 and the top surface 322 measured in a direction orthogonal to the cooking surface 12, the top surface 322, and/or the bottom surface 320.

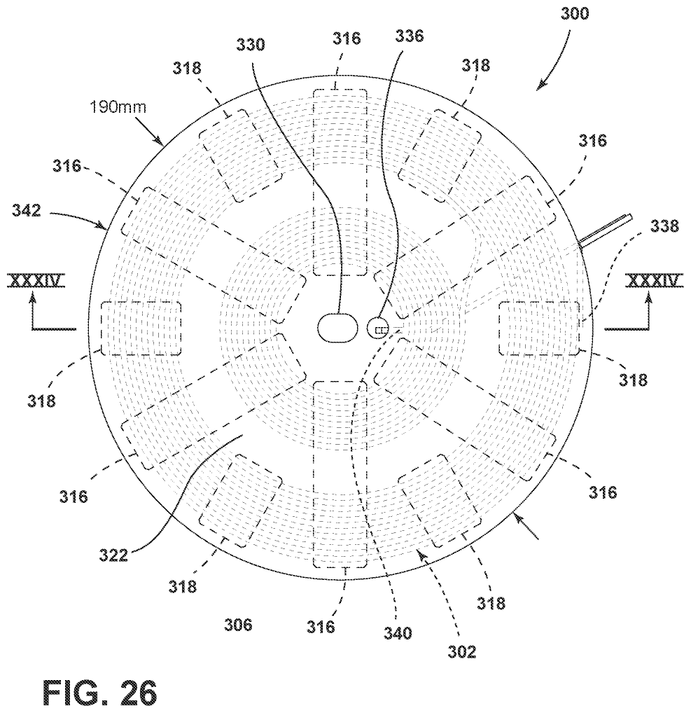

Referring now to FIG. 26, the pair of thermally resistant layers 304, 306 will be described in reference to the second thermally resistant layer 306, as the first thermally resistant layer 304 is substantially structurally similar to the first thermally resistant layer 304. Each of the pair of thermally resistant layers 304, 306 has a plate width 326 of 190 millimeters. As demonstrated, the pair of thermally resistant layers 304, 306 can define a stack width of the assembly, as the pair of thermally resistant layers 304, 306 can overhang the coil 302 and form the outermost points of the stack 300. Stated differently, the widest part of the stack 300 may be the pair of thermally resistant layers 304, 306.

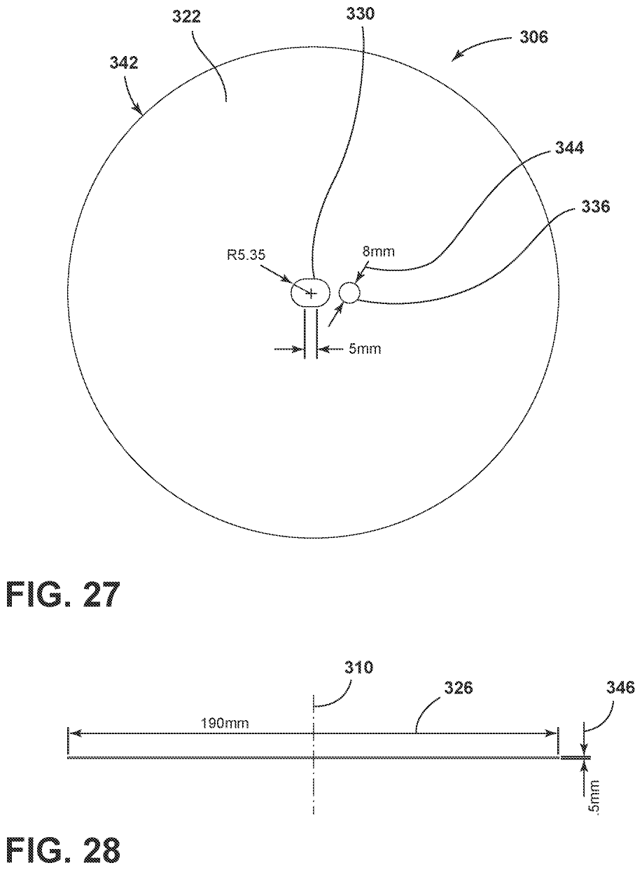

Referring now to FIGS. 27 and 28, the second layer 306, which may be structurally similar or identical to the first layer 304, defines a central slot 330 aligned with the central axis 310. The central slot 330 is configured to receive a temperature sensor and may have a stadium shape having radii of curvature of 5.35 millimeters and having a straight length of 5 millimeters.

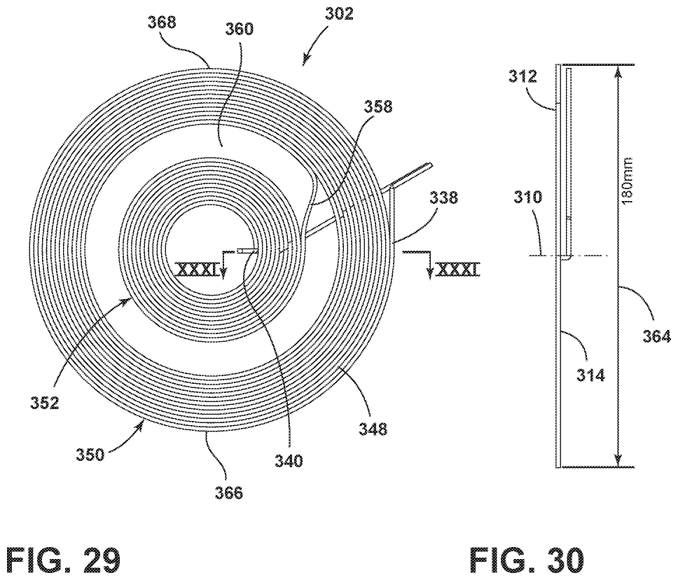

The second layer 306 further defines a passthrough hole 336 disposed adjacent to the central slot 330. The passthrough hole 336 is configured to receive a portion of the coil 302, such that when the stack 300 is assembled, two coil ends 338, 340 of the coil 302 (FIG. 29) may be accessed along an edge 342 of the stack 300. For example, the passthrough hole 336 can have a hole diameter 344 of 8 millimeters, which may be large enough to allow wire 348 of the coil 302 to pass through the second layer 306.

One or more of the thermally resistant layers 304, 306 has a plate height 346 of 0.5 millimeters. It is contemplated that the thermally resistant layers 304, 306 may be comprised of mica, such as mica sheeting. In some examples, the thermally resistant layers 304, 306 are made from muscovite or phlogopite mica. The thermally resistant layers 304, 306 may also be electrically insulative to limit current from arcing between adjacent turns of the coil 302. The thermally resistant layers 304, 306 may comprise magnesium, potassium, aluminum, and/or silica. The thermally resistant layers 304, 306 may include magnesium, aluminum, and silica. The thermally resistant layers 304, 306 may also, or alternatively, provide for mechanical stability to support the turns of the induction coil 302 to maintain the shape of the coil 302 and limit deformation. It is contemplated that the second layer 306 may be omitted in some examples, such that the top surface 322 of the stack 300 may be formed by the upper side 312 of the coil 302.

Referring now to FIGS. 29-31, the coil 302 includes wire 348 that forms an outer portion 350 and an inner portion 352 spaced from the outer portion 350. The wire 348 may be formed of Litz wire having individually insulated strands. The strands may be twisted or braided together forming windings, or turns, of the coil 302. In general, the wire 348 may provide for limited skin effect and proximity effect at high frequencies (e.g., the working frequency). For example, due to the skin effect, the flow of electric current tends to concentrate near the surface of a conductor. Litz wire may counteract this effect by providing the multiple insulated strands to distribute the current more evenly across a wire cross-sectional area.

The coil 302 includes a first coil end 338 and a second coil end 340. The first coil end 338 is disposed radially outwardly relative to the second coil end 340. The first coil end 338 may be coupled with the heating circuit 32 via connection between the pair of thermally resistant layers 304, 306 along the edge 342 of the stack 300, and the second coil end 340 may be coupled with the heating circuit 32 via access through the passthrough hole 336. For example, the wire 348 may pass through the passthrough hole 336 and extend radially outwardly toward the edge 342 of the stack 300 along the bottom side of the stack 300.

The portions of the coil 302 are connected with one another via an interconnecting portion 358 of the coil 302 that spans outer coil gap 360. For example, the outer interconnecting portion 358 spans an outer coil gap 360 to connect the outer portion 350 and the inner portion 352 together. It is contemplated that, while the coil ends 338, 340 and the interconnecting portion 358 may be substantially aligned along a common radius of the coil 302, in some examples, the interconnecting portion 358 may be circumferentially spaced, or offset, from one or both of the coil ends 338, 340.

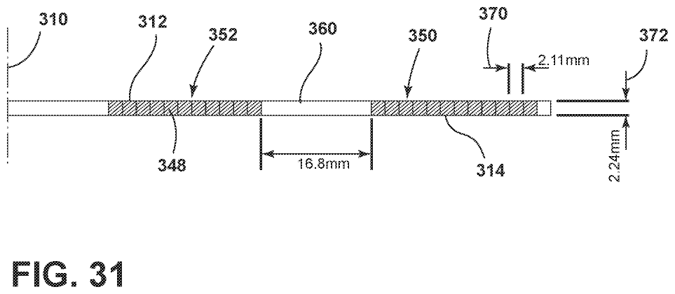

With particular reference to FIGS. 30 and 31, the coil 302 defines a coil width 364 of about 180 millimeters measured in a front-most part 366 to rear-most part 368 of the coil 302. The wire 348 has a wire width 370 of 2.11 millimeters. Accordingly, the pair of thermally resistant layers 304, 306 may overhang, or extend, radially past the coil 302 by about 5 millimeters, depending on the radial position of the coil 302.

The wire 348 may have a substantially square-shaped cross-section. For example, the wire 348 has a wire height 372 equivalent to the coil height of 2.24 millimeters. The cross-sectional area is 4.73 square millimeters. The outer portion 350 has 13 windings. The inner portion 352 has 11 windings. The coil 302 has an inductance of 50 microhenries and a resistance of 9 ohms. The outer coil gap 360 is 16.8 millimeters.

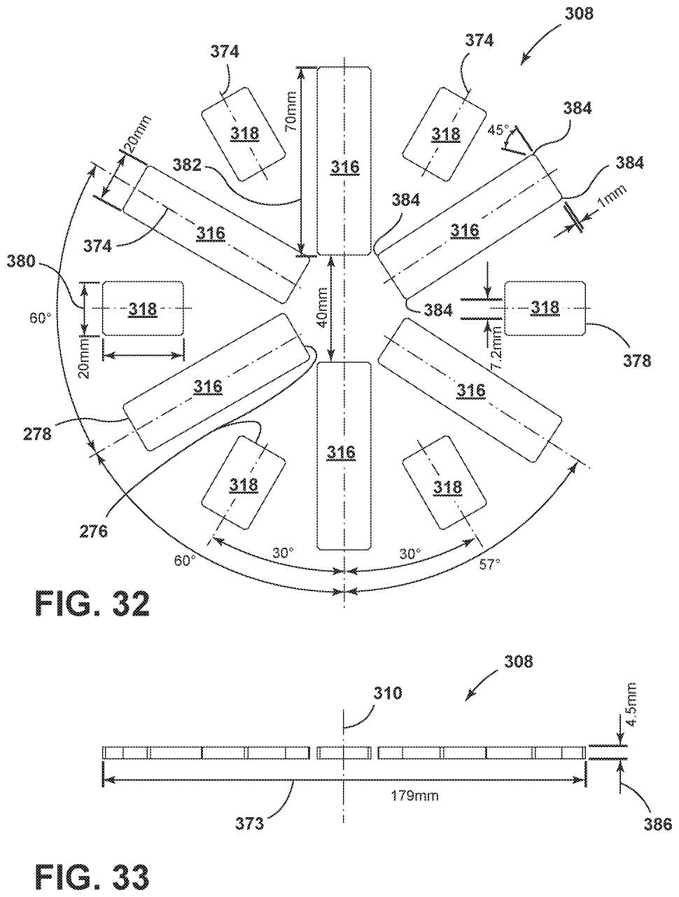

Referring now to FIGS. 32 and 33, the ferrite layer 308 includes ferrite material that may be a ceramic material with magnetic properties to direct the magnetic field generated by the coil 302. The ferrite layer 308 includes ceramic compounds that may include iron oxide combined with other metal oxides, such as zinc, nickel, and/or manganese to provide high magnetic permeability and low electrical conductivity. For example, the ferrite layer 308 includes a plurality of ferrites 316, 318 distributed in the ferrite layer 308 for shaping and focusing the magnetic fields produced by the coil 302, as well as the magnetic flux of the magnetic fields. The ferrites 316, 318 may be distributed evenly or unevenly. For example, the ferrites 316, 318 can be radially distributed evenly, while the individual shapes, lengths, and/or other dimensions of the ferrites 316, 318 may differ. In general, the ferrites 316, 318 may be rod- or bar-shaped to concentrate the magnetic field along the axis of the rod. This shape may be effective for creating a strong and focused magnetic field in a specific direction (e.g., radially inward or radially outwardly relative to the central axis 310).

The ferrite layer 308 has a ferrite layer width 373 of 179 millimeters. The plurality of ferrites 316, 318 includes a set of inner ferrites 316 and a set of outer ferrites 318, with the set of inner ferrites 316 extending more proximate to the central axis 310 relative to the set of outer ferrites 318. The set of inner ferrites 316 includes 6 ferrites 316 extending radially and evenly distributed about the central axis 310. The set of outer ferrites 318 also includes 6 ferrites extending radially and evenly distributed about the central axis 310. Accordingly, each of the set of inner ferrites 316 extends along an extension axis 374 central to each of the set of inner ferrites 316 that is 60 degrees offset from its adjacent inner ferrites 316, thereby forming a hexagonal distribution of the inner ferrites 316. Each inner ferrite 316 is radially spaced from the central axis 310 by about 20 millimeters at the extension axis 374. For example, each ferrite 316, 318 has a ferrite central end 376 and a ferrite peripheral end 378. The ferrite central end 376 of the inner ferrite 316 is spaced from the central axis 310 by about 20 millimeters at the extension axis 374. Each of the ferrites 316, 318 has a ferrite width 380 of 20 millimeters. The inner ferrites 316 have a ferrite length 382 of 70 millimeters. Further, each of the inner ferrites 316 and the outer ferrites 318 has 4 filleted vertices 384 each having legs (e.g., of a right triangle) equal to 1 millimeter. The inner ferrites 316 have a ferrite height 386 of 4.5 mm. Accordingly, each ferrite 316, 318 is substantially bar-shaped.

The set of outer ferrites 318 has the same ferrite width 380 as the set of inner ferrites 316 (e.g., 20 millimeters) and between 40 and 50% of the ferrite length 382 of the outer ferrites 318 (e.g., 45 millimeters). The outer ferrites 318 are distributed in the same way as the distribution of the inner ferrites 316 but offset by 30 degrees relative to the distribution of the inner ferrites 316. The ferrite peripheral end 378 of each of the inner ferrites 316 and the outer ferrites 318 are spaced from the central axis 310 by about 90 millimeters at the extension axis 374. The outer ferrites 318 similarly form rod-shaped bodies, and together, the inner and outer ferrites 316, 318 form a star-shaped distribution of the ferrite layer 308.

A circular area of the coil 302 (e.g., the area of the coil 302 parallel to the cooking surface 12 on one side of the coil 302) can influence the magnetic field strength and distribution generated by the coil 302. Further, the percentage of the circular area, or footprint, of the coil 302 covered by (or not covered by) the ferrite layer 308 can influence the distribution and flux of the magnetic field. Accordingly, the ferrite layer 308 may be sized, in terms of target area, volume, or the like, to provide enhanced magnetic field guidance. For example, the circular area of the coil 302 may be between 20,000 and 30,000 square millimeters. In the present example, the circular area of the coil 302 is about 25,000 square millimeters, and the target area (e.g., footprint area) of the ferrite layer 308 may be about 12,000 square millimeters. The target area of the ferrite layer 308 may be between 10,000 square millimeters and 14,000 square millimeters. Accordingly, the ferrite layer 308 may cover about 50% of the circular area of the coil 302. In this way, the magnetic fields may be focused directly to the cookware 14.

The distribution of the ferrite layer 308 enhances magnetic flux of the magnetic field by providing multiple sources relatively evenly distributed about the central axis 310. The enhanced magnetic properties provided by the ferrite layer 308, coupled with the ferrite layer width 373, provide for slim yet efficient functionality of the induction coil assembly 300.

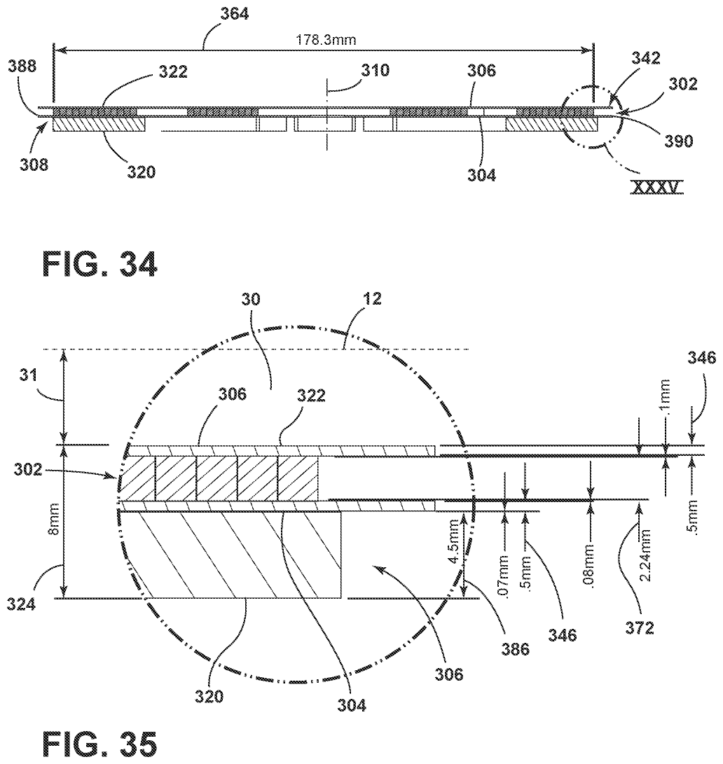

Referring now to FIGS. 34 and 35, the coil 302 has a cross-sectional width of 178.3 millimeters measured between a left-most part 388 to right-most part 390 of the coil 302. The stack 300 has an assembly height 324 of 8 millimeters, which is comprised of each plate height 346 (0.5 millimeters×2), the coil height 372 of 2.24 millimeters, and the ferrite height 386 of 4.5 millimeters. It is contemplated that stack 300 may maintain room for minor expansion or retraction (e.g., tolerance) of the components of the stack 300 that amount to about 0.25 millimeters. The top surface 322 of the stack 300 can be spaced from the cooking surface 12 by between 2.5 millimeters and 7 millimeters.

While specific parameters of the third induction coil assembly 300 are shown and described, it is contemplated that these parameters may differ without deviating from the aspects of the third induction coil assembly 300. For example, ratios, percentages, or proportions may differ. For example, the spacings between the outer portion 350, the inner portion 352, and the intermediate portions 354, as a ratio to the number of windings, may be similar in a third induction coil assembly 300 that is bigger or smaller than the example shown and described. For example, the various dimensional values and/or electrical values may be in the range of +/−10-20% of the listed value.

In general, the short stack height 324 of the third induction coil assembly 300 provides for enhanced space saving within the induction cooktop 10. By incorporating the full-bridge circuit in combination with a higher-resistance coil 302 and distribution of ferrites of the ferrite layer 308, a lower-cost dynamic solution may be provided.

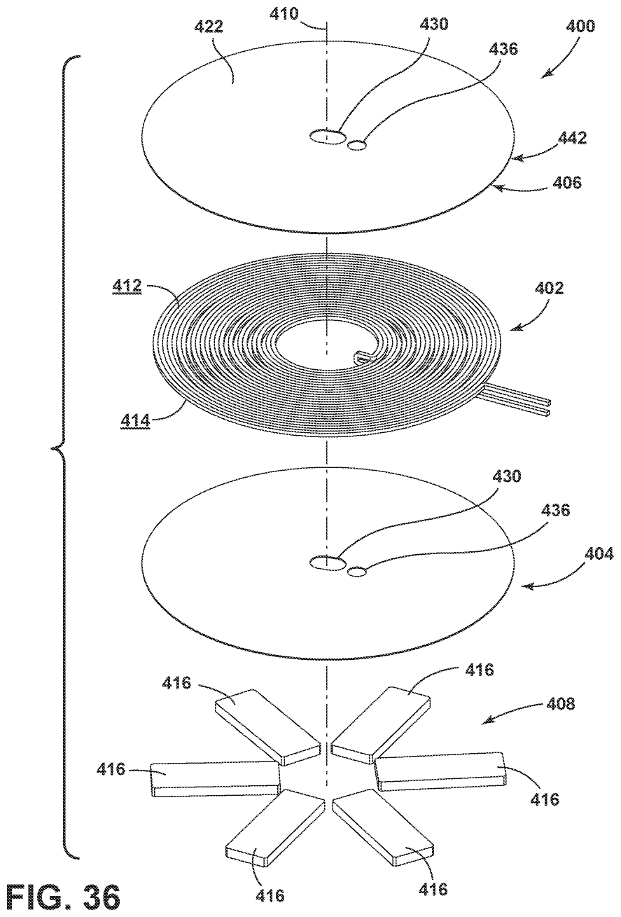

Referring now to FIGS. 36-46, a fourth induction coil assembly 400 is configured for operation with the heating circuit 32 of the present cooktop 10.

Referring more particularly to FIG. 36, the induction coil assembly 400 includes a coil 402, a pair of thermally resistant layers 404, 406, and a ferrite layer 408 each disposed on a central axis 410. The coil includes an upper side 412 and a lower side 414. The pair of thermally resistant layers 404, 406 engage the lower side 414 and the upper side 412, respectively. For example, the pair of thermally resistant layers 404, 406 can include a first layer 404 that engages the lower side 414 of the coil and a second layer 406 that engages the upper side 412 of the coil 402. In this way, the pair of thermally resistant layers 404, 406 sandwich, or pancake, the coil 402. The ferrite layer 408 is disposed under the first thermally resistant layer 404 and includes a plurality of ferrites 416. The coil 402, the pair of thermally resistant layers 404, 406, and the ferrite layer 408 are stacked together to form the induction coil assembly 400, with the ferrite layer 408 defining a bottom surface 420 of the stack 400 and the second thermally resistant layer 406 forming a top surface 422 of the stack 400. An assembly height 424 is defined between the bottom surface 420 and the top surface 422 measured in a direction orthogonal to the cooking surface 12, the top surface 422, and/or the bottom surface 420.

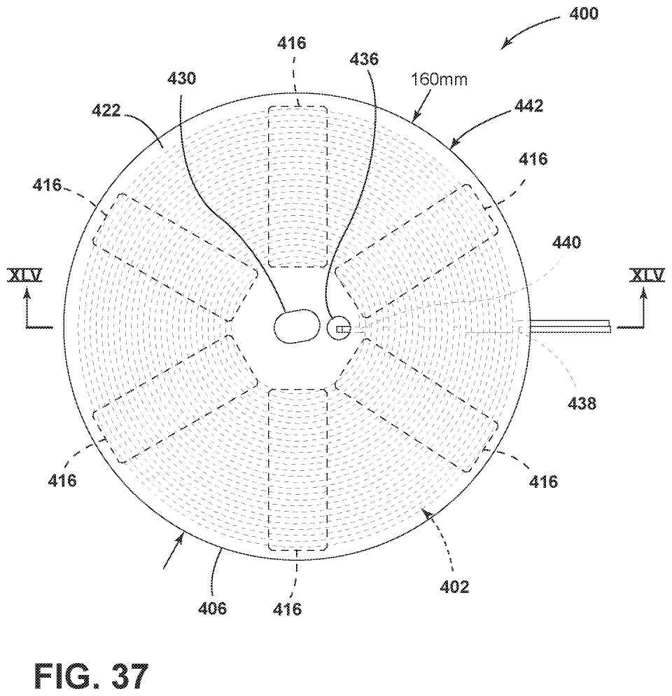

Referring now to FIG. 37, the pair of thermally resistant layers 404, 406 will be described in reference to the second thermally resistant layer 406, as the first thermally resistant layer 404 is substantially structurally similar to the first thermally resistant layer 404. Each of the pair of thermally resistant layers 404, 406 has a plate width 426 of 160 millimeters (FIG. 39). As demonstrated, the pair of thermally resistant layers 404, 406 can define a stack width of the assembly, as the pair of thermally resistant layers 404, 406 can overhang the coil 402 and form the outermost points of the stack 400. Stated differently, the widest part of the stack 400 may be the pair of thermally resistant layers 404, 406.

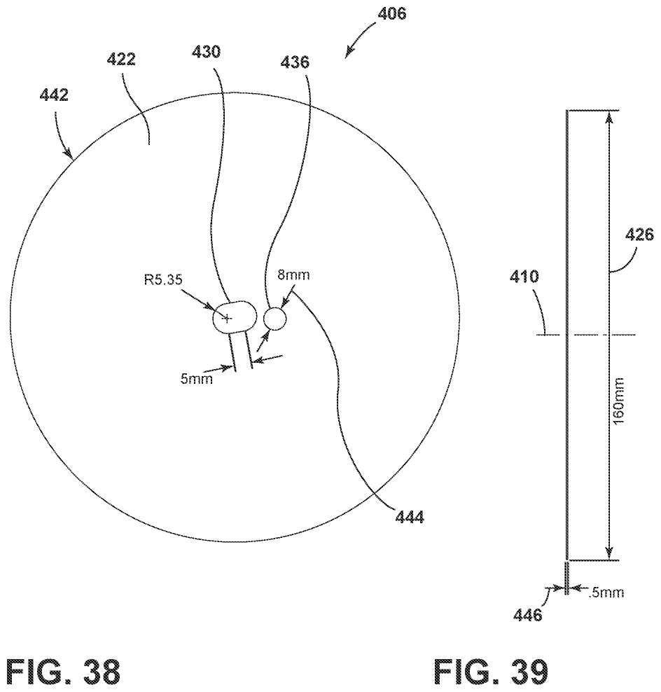

Referring now to FIGS. 38 and 39, the second layer 406, which may be structurally similar or identical to the first layer 404, defines a central slot 430 aligned with the central axis 410. The central slot 430 is configured to receive a temperature sensor and may have a stadium shape having radii of curvature of 5.35 millimeters and having a straight length of 5 millimeters.

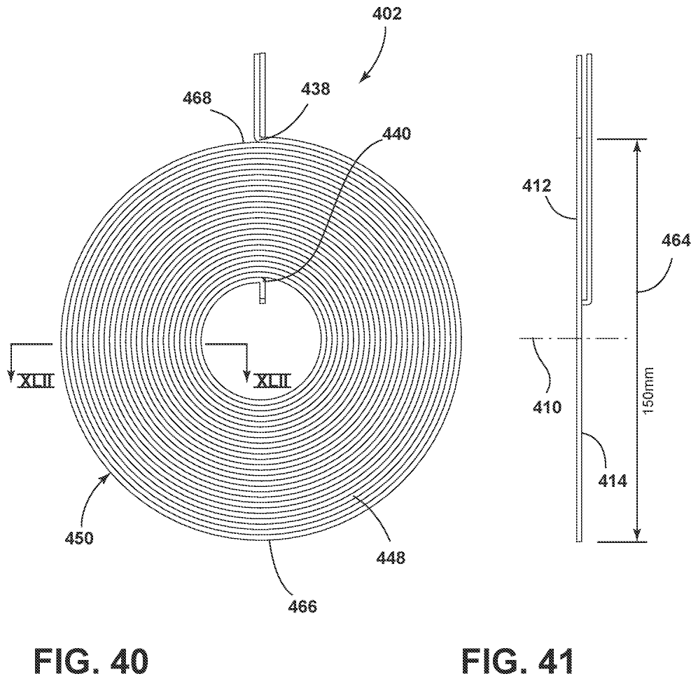

The second layer 406 further defines a passthrough hole 436 disposed adjacent to the central slot 430. The passthrough hole 436 is configured to receive a portion of the coil 402, such that when the stack 400 is assembled, two coil ends 438, 440 of the coil 402 (FIG. 40) may be accessed along an edge 442 of the stack 400. For example, the passthrough hole 436 can have a hole diameter 444 of 8 millimeters, which may be large enough to allow wire 448 of the coil 402 to pass through the second layer 406.

One or more of the thermally resistant layers 404, 406 has a plate height 446 of 0.5 millimeters. It is contemplated that the thermally resistant layers 404, 406 may be comprised of mica, such as mica sheeting. In some examples, the thermally resistant layers 404, 406 are made from muscovite or phlogopite mica. The thermally resistant layers 404, 406 may also be electrically insulative to limit current from arcing between adjacent turns of the coil 402. The thermally resistant layers 404, 406 may comprise magnesium, potassium, aluminum, and/or silica. The thermally resistant layers 404, 406 may include magnesium, aluminum, and silica. The thermally resistant layers 404, 406 may also, or alternatively, provide for mechanical stability to support the turns of the induction coil 402 to maintain the shape of the coil 402 and limit deformation. It is contemplated that the second layer 406 may be omitted in some examples, such that the top surface 422 of the stack 400 may be formed by the upper side 412 of the coil 402.

Referring now to FIGS. 40-42, the coil 402 includes wire 448 that forms a single coil portion 450 with abutting windings. For example, there may be no coil gaps akin to the coil gaps of the other examples described here. The wire 448 may be formed of Litz wire having individually insulated strands. The strands may be twisted or braided together forming windings, or turns, of the coil 402. In general, the wire 448 may provide for limited skin effect and proximity effect at high frequencies (e.g., the working frequency). For example, due to the skin effect, the flow of electric current tends to concentrate near the surface of a conductor. Litz wire may counteract this effect by providing the multiple insulated strands to distribute the current more evenly across a wire cross-sectional area.

The coil 402 includes a first coil end 438 and a second coil end 440. The first coil end 438 is disposed radially outwardly relative to the second coil end 440. The first coil end 438 may be coupled with the heating circuit 32 via connection between the pair of thermally resistant layers 404, 406 along the edge 442 of the stack 400, and the second coil end 440 may be coupled with the heating circuit 32 via access through the passthrough hole 436. For example, the wire 448 may pass through the passthrough hole 436 and extend radially outwardly toward the edge 442 of the stack 400 along the bottom side of the stack 400.

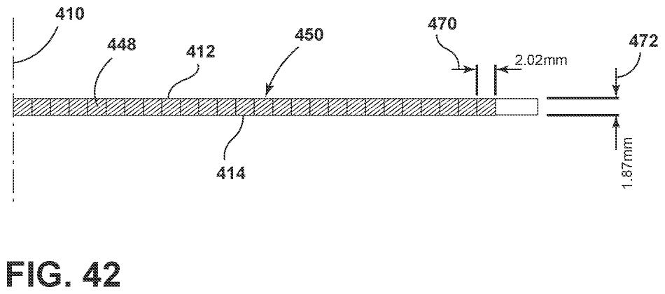

With particular reference to FIGS. 41 and 42, the coil 402 defines a coil width 464 of about 150 millimeters measured in a front-most part 466 to rear-most part 468 of the coil 402. The wire 448 has a wire width of 2.02 millimeters. Accordingly, the pair of thermally resistant layers 404, 406 may overhang, or extend, radially past the coil 402 by about 5 millimeters, depending on the radial position of the coil 402.

The wire 448 may have a substantially square-shaped cross-section. For example, the wire 448 has a wire height 472 equivalent to the coil height of 1.87 millimeters. The cross-sectional area is 3.78 square millimeters. The coil portion 450 has 26 windings. The coil 402 has an inductance of 60 microhenries and a resistance of 11 ohms.

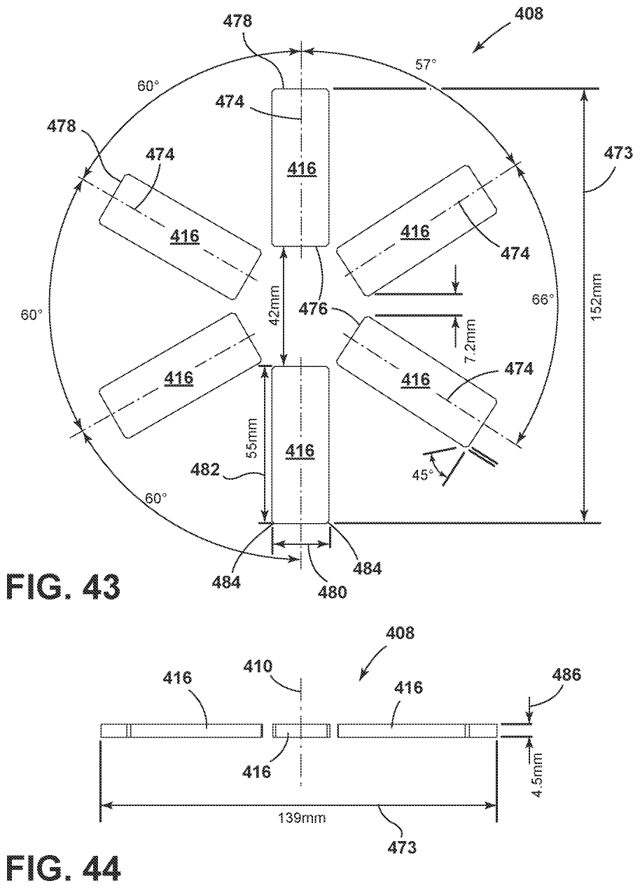

Referring now to FIGS. 43 and 44, the ferrite layer 408 includes ferrite material that may be a ceramic material with magnetic properties to direct the magnetic field generated by the coil 402. The ferrite layer 408 includes ceramic compounds that may include iron oxide combined with other metal oxides, such as zinc, nickel, and/or manganese to provide high magnetic permeability and low electrical conductivity. For example, the ferrite layer 408 includes a plurality of ferrites 416 distributed in the ferrite layer 408 for shaping and focusing the magnetic fields produced by the coil 402, as well as the magnetic flux of the magnetic fields. The ferrites 416 may be distributed evenly or unevenly. For example, the ferrites 416 can be radially distributed evenly, while the individual shapes, lengths, and/or other dimensions of the ferrites 416 may differ. In general, the ferrites 416 may be rod- or bar-shaped to concentrate the magnetic field along the axis of the rod. This shape may be effective for creating a strong and focused magnetic field in a specific direction (e.g., radially inward or radially outwardly relative to the central axis 410).

The ferrite layer 408 has a ferrite layer width 473 of 152 millimeters. The set of ferrites 416 includes 6 ferrites 416 extending radially and evenly distributed about the central axis 410. Accordingly, each of the set of ferrites 416 extends along an extension axis 474 central to each of the set of ferrites 416 that is 60 degrees offset from its adjacent ferrites 416, thereby forming a hexagonal distribution of the ferrites 416. Each ferrite 416 is radially spaced from the central axis 410 by about 21 millimeters at the extension axis 474. For example, each ferrite 416 has a ferrite central end 476 and a ferrite peripheral end 478. The ferrite central end 476 of the ferrite 416 is spaced from the central axis 410 by about 21 millimeters at the extension axis 474. Each of the ferrites 416 has a ferrite width 480 of 20 millimeters. The ferrites 416 have a ferrite length 482 of 55 millimeters. Further, each of the ferrites 416 has 4 filleted vertices 484 each having legs (e.g., of a right triangle) equal to 1 millimeter. The ferrites 416 have a ferrite height 486 of 4.5 mm. Accordingly, each ferrite 416 is substantially bar-shaped. The ferrite peripheral end 478 of each of the ferrites 416 is spaced from the central axis 410 by about 70 millimeters at the extension axis 474.

A circular area of the coil 402 (e.g., the area of the coil 402 parallel to the cooking surface 12 on one side of the coil 402) can influence the magnetic field strength and distribution generated by the coil 402. Further, the percentage of the circular area, or footprint, of the coil 402 covered by (or not covered by) the ferrite layer 408 can influence the distribution and flux of the magnetic field. Accordingly, the ferrite layer 408 may be sized, in terms of target area, volume, or the like, to provide enhanced magnetic field guidance. For example, the circular area of the coil 402 may be between 15,000 and 25,000 square millimeters. In the present example, the circular area of the coil 402 is about 17,700 square millimeters, and the target area (e.g., footprint area) of the ferrite layer 408 may be about 6,600 square millimeters. The target area of the ferrite layer 408 may be between 5,000 square millimeters and 8,000 square millimeters. Accordingly, the ferrite layer 408 may cover between 30% and 40% of the circular area of the coil 402. In this way, the magnetic fields may be focused directly to the cookware 14.

The distribution of the ferrite layer 408 enhances magnetic flux of the magnetic field by providing multiple sources relatively evenly distributed about the central axis 410. The enhanced magnetic properties provided by the ferrite layer 408, coupled with the ferrite layer width 473, provide for slim yet efficient functionality of the induction coil assembly 400.

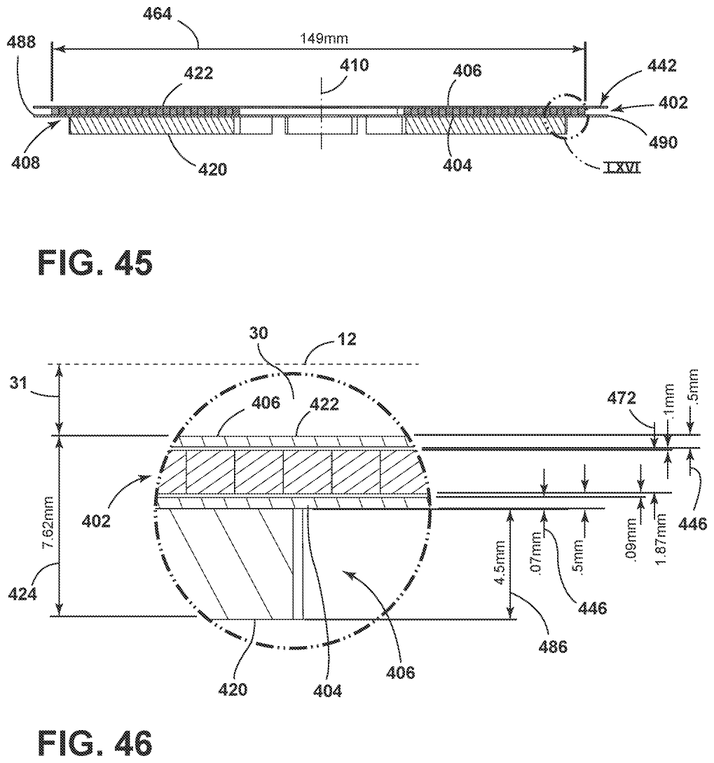

Referring now to FIGS. 45 and 46, the coil 402 has a cross-sectional width of 149 millimeters measured between a left-most part 488 to right-most part 490 of the coil 402. The stack 400 has an assembly height 424 of 7.62 millimeters, which is comprised of each plate height 446 (0.5 millimeters×2), the coil height 472 of 1.87 millimeters, and the ferrite height 486 of 4.5 millimeters. It is contemplated that stack 400 may maintain room for minor expansion or retraction (e.g., tolerance) of the components of the stack 400 that amount to about 0.26 millimeters. The top surface 422 of the stack 400 can be spaced from the cooking surface 12 by between 2.5 millimeters and 7 millimeters.

While specific parameters of the fourth induction coil assembly 400 are shown and described, it is contemplated that these parameters may differ without deviating from the aspects of the fourth induction coil assembly 400. For example, ratios, percentages, or proportions may differ. For example, the various dimensional values and/or electrical values may be in the range of +/−10-20% of the listed value.

In general, the short stack height 424 of the fourth induction coil assembly 400 provides for enhanced space saving within the induction cooktop 10. By incorporating the full-bridge circuit in combination with a higher-resistance coil 402 and distribution of ferrites of the ferrite layer 408, a lower-cost dynamic solution may be provided.

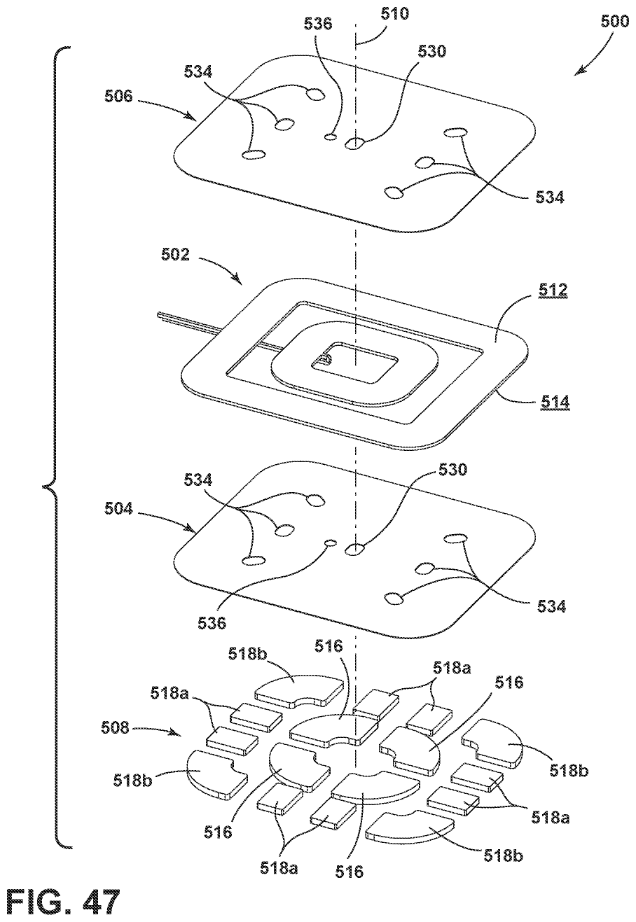

Referring now to FIGS. 47-57, a fourth induction coil assembly 500 is configured for operation with the heating circuit 32 of the present cooktop 10. The fourth induction coil assembly 500 may have a rectangular shape, with corner of the rectangles being arcuate to accommodate curvature of windings and the other components (e.g., the ferrites).

Referring more particularly to FIG. 47, the induction coil assembly 500 includes a coil 502, a pair of thermally resistant layers 504, 506, and a ferrite layer 508 each disposed on a central axis 510. The coil includes an upper side 512 and a lower side 514. The pair of thermally resistant layers 504, 506 engage the lower side 514 and the upper side 512, respectively. For example, the pair of thermally resistant layers 504, 506 can include a first layer 504 that engages the lower side 514 of the coil and a second layer 506 that engages the upper side 512 of the coil 502. In this way, the pair of thermally resistant layers 504, 506 sandwich, or pancake, the coil 502. The ferrite layer 508 is disposed under the first thermally resistant layer 504 and includes a plurality of ferrites 516, 518a, 518b. The coil 502, the pair of thermally resistant layers 504, 506, and the ferrite layer 508 are stacked together to form the induction coil assembly 500, with the ferrite layer 508 defining a bottom surface 520 of the stack 500 and the second thermally resistant layer 506 forming a top surface 522 of the stack 500. An assembly height 524 is defined between the bottom surface 520 and the top surface 522 measured in a direction orthogonal to the cooking surface 12, the top surface 522, and/or the bottom surface 520.

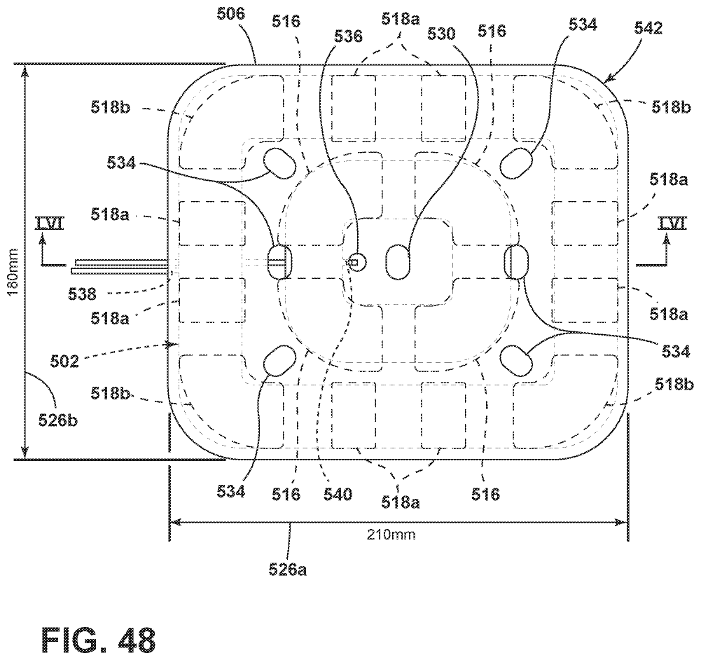

Referring now to FIG. 48-50, the pair of thermally resistant layers 504, 506 will be described in reference to the second thermally resistant layer 506, as the first thermally resistant layer 504 is substantially structurally similar to the first thermally resistant layer 504. Each of the pair of thermally resistant layers 504, 506 has a first plate width 526a of 210 millimeters and a second plate width 526b of 180 millimeters. As demonstrated, the pair of thermally resistant layers 504, 506 can define a stack width of the assembly, as the pair of thermally resistant layers 504, 506 can overhang the coil 502 and form the outermost points of the stack 500. Stated differently, the widest part of the stack 500 may be the pair of thermally resistant layers 504, 506.

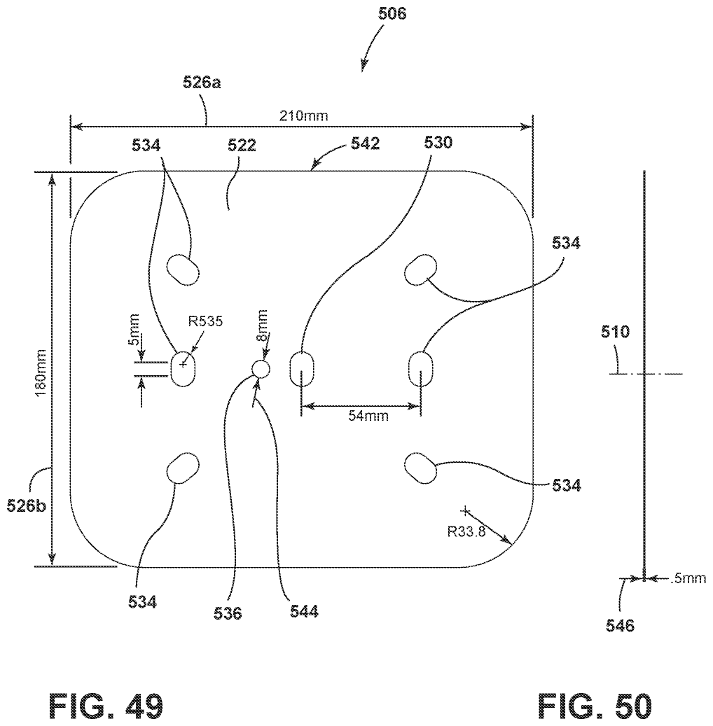

Referring now to FIGS. 49 and 50, the second layer 506, which may be structurally similar or identical to the first layer 504, defines a central slot 530 aligned with the central axis 510. The central slot 530 is configured to receive a temperature sensor and may have a stadium shape having radii of curvature of 5.35 millimeters and having a straight length of 5 millimeters. Each of the pair of thermally resistant layers 504, 506 may define one or more peripheral slots 534 spaced radially outwardly from the central slot 530.

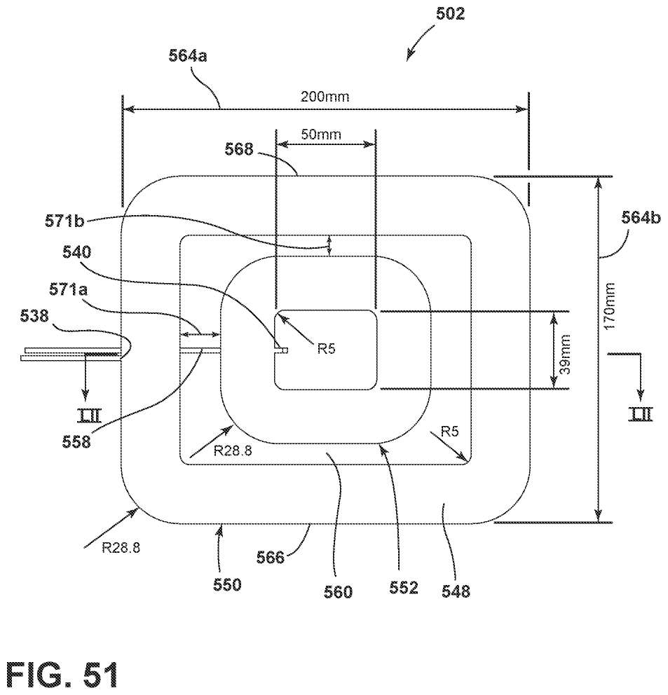

The second layer 506 further defines a passthrough hole 536 disposed adjacent to the central slot 530. The passthrough hole 536 is configured to receive a portion of the coil 502, such that when the stack 500 is assembled, two coil ends 538, 540 of the coil 502 (FIG. 51) may be accessed along an edge 542 of the stack 500. For example, the passthrough hole 536 can have a hole diameter 544 of 8 millimeters, which may be large enough to allow wire 548 of the coil 502 to pass through the second layer 506.

One or more of the thermally resistant layers 504, 506 has a plate height 546 of 0.5 millimeters. It is contemplated that the thermally resistant layers 504, 506 may be comprised of mica, such as mica sheeting. In some examples, the thermally resistant layers 504, 506 are made from muscovite or phlogopite mica. The thermally resistant layers 504, 506 may also be electrically insulative to limit current from arcing between adjacent turns of the coil 502. The thermally resistant layers 504, 506 may comprise magnesium, potassium, aluminum, and/or silica. The thermally resistant layers 504, 506 may include magnesium, aluminum, and silica. The thermally resistant layers 504, 506 may also, or alternatively, provide for mechanical stability to support the turns of the induction coil 502 to maintain the shape of the coil 502 and limit deformation. It is contemplated that the second layer 506 may be omitted in some examples, such that the top surface 522 of the stack 500 may be formed by the upper side 512 of the coil 502.

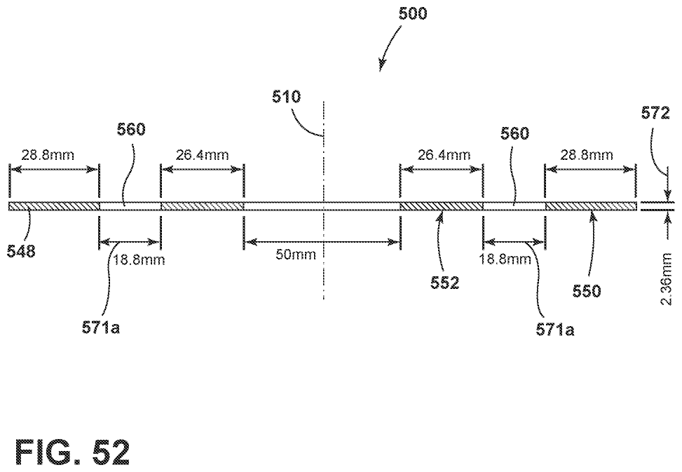

Referring now to FIGS. 51-52, the coil 502 includes wire 548 that forms an outer portion 550 and an inner portion 552 spaced from the outer portion 550. The wire 548 may be formed of Litz wire having individually insulated strands. The strands may be twisted or braided together forming windings, or turns, of the coil 502. In general, the wire 548 may provide for limited skin effect and proximity effect at high frequencies (e.g., the working frequency). For example, due to the skin effect, the flow of electric current tends to concentrate near the surface of a conductor. Litz wire may counteract this effect by providing the multiple insulated strands to distribute the current more evenly across a wire cross-sectional area.

The coil 502 includes a first coil end 538 and a second coil end 540. The first coil end 538 is disposed further from the central axis 510 than the second coil end 540 is from the central axis 510. The first coil end 538 may be coupled with the heating circuit 32 via connection between the pair of thermally resistant layers 504, 506 along the edge 542 of the stack 500, and the second coil end 540 may be coupled with the heating circuit 32 via access through the passthrough hole 536. For example, the wire 548 may pass through the passthrough hole 536 and extend radially outwardly toward the edge 542 of the stack 500 along the bottom side of the stack 500.

The portions of the coil 502 are connected with one another via an interconnecting portion 558 of the coil 502 that span a coil gap 560. For example, the interconnecting portion 558 spans the coil gap 502 to connect the outer portion 550 and the inner portion 552 together. It is contemplated that, while the coil ends 538, 540 and the interconnecting portion 558 may be substantially aligned along a common ray (e.g., to the left) of the coil 502, but in some examples, the interconnecting portion 558 is circumferentially spaced, or offset, from one or both of the coil ends 538, 540.

With continued reference to FIGS. 51 and 52, the coil 502 defines a first coil width 564a of about 200 millimeters measured in side-to-side direction and a second coil width 564b of about 170 millimeters measured in a front-to-back direction. The wire 548 has a wire width of 2.4 mm. The pair of thermally resistant layers 504, 506 may overhang, or extend, past the coil 502 by about 5 millimeters, depending on the frontward/sideward position along the edge 542.

The wire 548 may have a substantially square-shaped cross-section similar to the other examples described herein. The wire 548 can have a wire height 572 equivalent to the coil height of 2.36 millimeters. The outer portion 550 has 12 windings. The inner portion 552 has 11 windings. The coil 502 has an inductance of 55 microhenries and a resistance of 8 ohms. The coil gap 560 has varying depths 571a, 571b. For example, the gap 560 can have a lateral depth 571 measured laterally between the outer portion 550 and the inner portion 552 along right and left sides of the gap 560 of 18.8 millimeters. The gap 560 can have a medial depth 571b measured medially between the outer portion 550 and the inner portion 552 along front and back sides of the gap 560 of 10.3 millimeters.

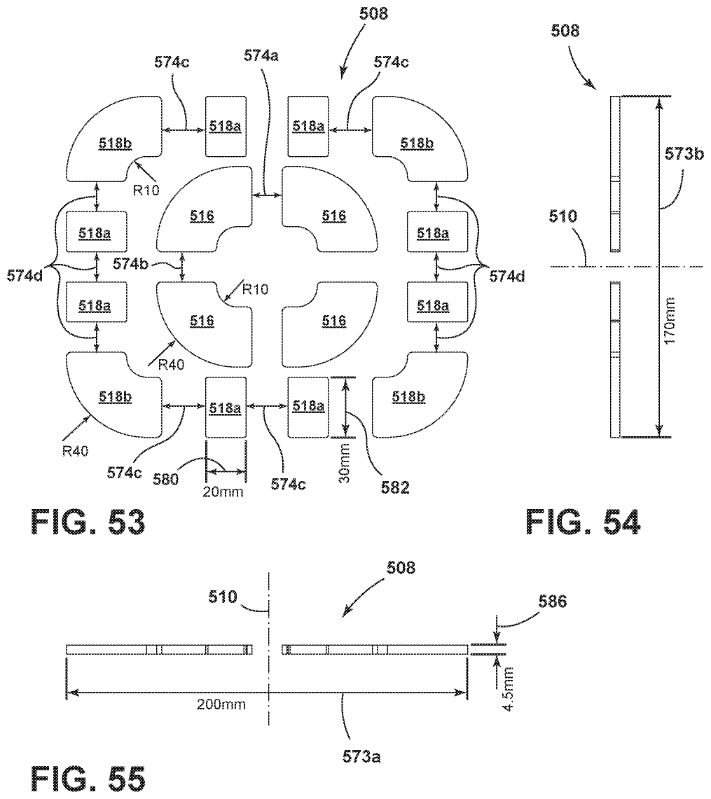

Referring now to FIGS. 53-55, the ferrite layer 508 includes ferrite material that may be a ceramic material with magnetic properties to direct the magnetic field generated by the coil 502. The ferrite layer 508 includes ceramic compounds that may include iron oxide combined with other metal oxides, such as zinc, nickel, and/or manganese to provide high magnetic permeability and low electrical conductivity. For example, the ferrite layer 508 includes a plurality of ferrites 516, 518a, 518b distributed in the ferrite layer 508 for shaping and focusing the magnetic fields produced by the coil 502, as well as the magnetic flux of the magnetic fields.

The ferrites 516, 518a, 518b may be distributed evenly or unevenly. For example, the inner ferrites 516 may form an oblong shape or pill-shape forming rounded corners that lay under the inner portion 552. The each pair of adjacent inner ferrites 516 are spaced from one another by a first span 574a measured in a direction parallel to the first width 564a and by a second span 574b measured in a direction parallel to the second width 564b. The first span 574a may be 15 millimeters. The second span 574b may be 15 millimeters.

The outer ferrites 518a, 518b include intermediate ferrites 518a distributed along the sides, front, and rear of the ferrite layer 508, and corner ferrites 518b disposed at the corners of the ferrite layer 508. The intermediate ferrites 518a are spaced along the front and rear from adjacent ferrites 518a, 518b by a third span 574c of about 22 millimeters and are spaced along the sides from adjacent ferrites 518a, 518b by a fourth span 574d of about 15 millimeters.

Each of the intermediate ferrites 518a has a ferrite width 580 of 20 millimeters and a ferrite length 582 of 30 millimeters. Further, each of the inner ferrites 516 and the outer ferrites 518a, 518b has 4 filleted vertices 584 each having legs (e.g., of a right triangle) equal to 1 millimeter.

A footprint of the coil 502 (e.g., the area of the coil 502 parallel to the cooking surface 12 on one side of the coil 502) can influence the magnetic field strength and distribution generated by the coil 502. Further, the percentage of the area, or footprint, of the coil 502 covered by (or not covered by) the ferrite layer 508 can influence the distribution and flux of the magnetic field. Accordingly, the ferrite layer 508 may be sized, in terms of target area, volume, or the like, to provide enhanced magnetic field guidance. For example, the footprint of the coil 502 may have two target areas corresponding to footprints of the outer portion 550 and the inner portion 552 which overlay the outer ferrites 518a, 51b and the inner ferrites 516 accordingly. In this way, the ferrite layer 508 can be geometrically aligned with the portions 550, 552 in terms of footprint.

The distribution of the ferrite layer 508 enhances magnetic flux of the magnetic field by providing multiple sources relatively evenly distributed about the central axis 510. The enhanced magnetic properties provided by the ferrite layer 508, coupled with the ferrite layer widths 573a, 573b, provide for slim yet efficient functionality of the induction coil assembly 500.

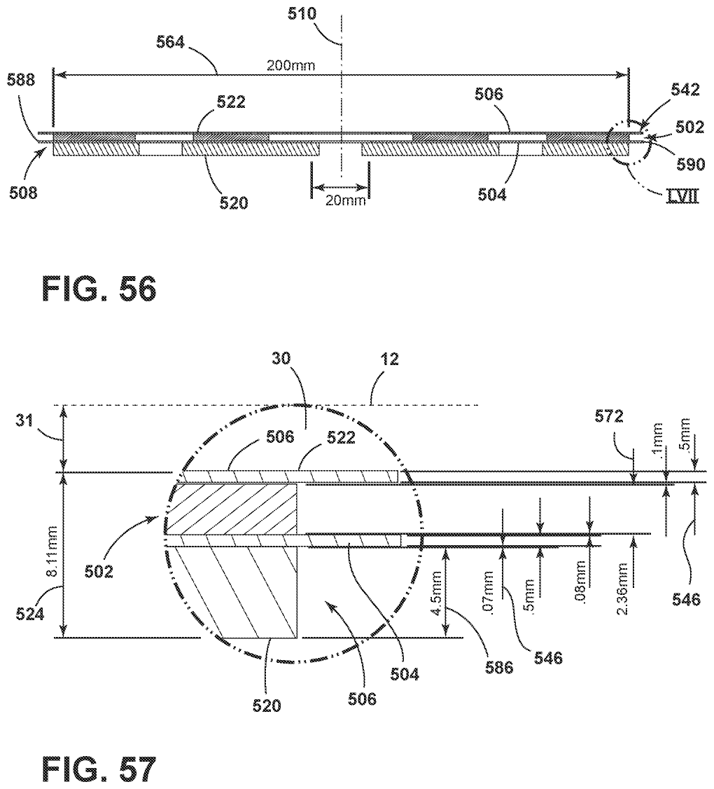

Referring now to FIGS. 56 and 57, the stack 500 has an assembly height 524 of 8.11 millimeters, which is comprised of each plate height 546 (0.5 millimeters×2), the coil height 570 of 2.36 millimeters, and the ferrite height 586 of 4.5 millimeters. It is contemplated that stack 500 may maintain room for minor expansion or retraction (e.g., tolerance) of the components of the stack 500 that amount to about 0.25 millimeters. The top surface 522 of the stack 500 can be spaced from the cooking surface 12 by between 2.5 millimeters and 7 millimeters.

While specific parameters of the fourth induction coil assembly 500 are shown and described, it is contemplated that these parameters may differ without deviating from the aspects of the fourth induction coil assembly 500. For example, ratios, percentages, or proportions may differ. For example, the spacings between the outer portion 550 and the inner portion 552, as well as a ratio to the number of windings, may be similar in a fifth induction coil assembly 500 that is bigger or smaller than the example shown and described. For example, the various dimensional values and/or electrical values may be in the range of +/−10-20% of the listed value.

In general, the short stack height 524 of the fourth induction coil assembly 500 provides for enhanced space saving within the induction cooktop 10. By incorporating the full-bridge circuit in combination with a higher-resistance coil 502 and distribution of ferrites of the ferrite layer 508, a lower-cost dynamic solution may be provided.

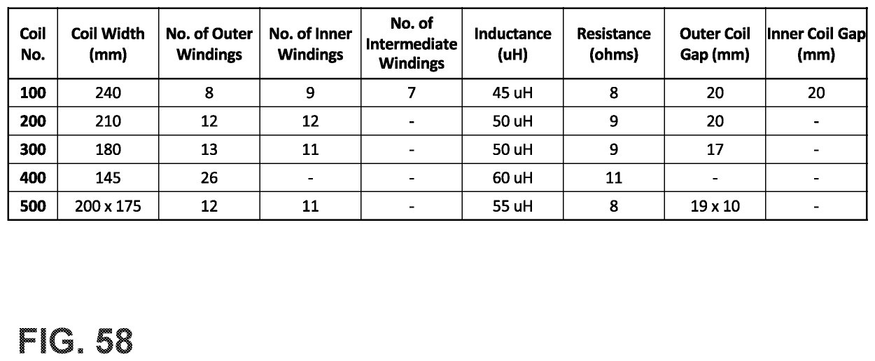

Referring generally to FIG. 58, a table demonstrating a breakdown of approximate parameters for each of the induction coil assemblies 100, 200, 300, 400, 500 described herein is demonstrated. It is contemplated that these parameters are approximate. For example, there may be standard variance in the dimensions/parameters, such as the spacing between portions, which may vary as the induction heater coil 10 turns in on itself. Further, minor tolerances (e.g., +/−10%) may be summarized in the table shown.

In general, the induction coil assemblies 100, 200, 300, 400, 500 constructed according to the aspects described above provide for a light-weight, thermally-efficient, and slim solution for enhanced operation at high voltage (e.g., via full-bridge inverter 44). For example, the induction heater coil 10 of the induction coil assemblies 100, 200, 300, 400, 500 can have a weight of less than 300 grams and a height previously described. By working at high voltage, the circulating current is lower and it is therefore possible to use a wire with a small section, therefore less copper and therefore lower costs.

The invention disclosed herein is further summarized in the following paragraphs and is further characterized by combinations of any and all of the various aspects described therein.

According to one aspect of the present disclosure, an induction cooktop includes a cooking surface operable to support cookware and a resonant circuit having a resonant frequency in the range of 40 kHz to 60 kHz. The resonant circuit includes a capacitor having capacitance of between 0.1 micro-Farads and 0.6 micro-Farads and a coil disposed under the cooking surface and configured to operate at a working frequency of between 50 kHz and 150 kHz. The induction cooktop includes an induction control circuit configured to power the resonant circuit at the working frequency.

According to one aspect, the induction control circuit includes a full-bridge inverter that controls current through the coil.

According to one aspect, the resonant circuit is configured to have an equivalent alternating-current (AC) resistance of between 8 ohms and 15 ohms at the working frequency when cookware overlays the coil and includes a bottom made of AISI 430.

According to one aspect, the inductance of the coil is between 45 micro-Henries and 60 micro-Henries when the equivalent resistance is between 8 and 15 ohms at the working frequency.

According to one aspect, the coil includes wire forming a plurality of windings and having a height in a direction orthogonal to the cooking surface of between 1.5 millimeters and 2.5 millimeters.

According to one aspect, the wire has a width in a direction parallel to the cooking surface of between 1.5 millimeters and 3 millimeters.

According to one aspect, a cross-sectional area of the wire is between 1.8 square millimeters and 3.0 square millimeters.

According to one aspect, a total weight of the coil is less than 300 grams.

According to one aspect, the coil is spaced below the cooking surface by at most 7 millimeters.

According to one aspect, the coil is part of an induction coil assembly that includes a ferrite layer spaced from and below the coil, wherein the ferrite layer includes a plurality of ferrites having a height in a direction orthogonal to the cooking surface of between 3 millimeters and 5 millimeters.

According to one aspect, the induction coil assembly has a stack height in a direction orthogonal to the cooking surface between a bottom surface of the induction coil assembly and a top surface of the of the induction coil assembly between 7 millimeters and 10 millimeters.

According to another aspect of the present disclosure, an induction coil assembly for an induction cooktop includes a cooking surface operable to support cookware and a resonant circuit having a resonant frequency in the range of 40 kHz to 60 kHz. The resonant circuit includes a capacitor having capacitance of between 0.1 uF and 0.6 uF and a coil disposed under the cooking surface and configured to operate at a working frequency of between 50 kHz and 150 kHz. An induction control circuit is configured to power the resonant circuit at the working frequency via a full-bridge inverter.

According to one aspect, the resonant circuit is configured to have an equivalent alternating-current (AC) resistance of between 8 ohms and 15 ohms at the working frequency when cookware overlays the coil and includes a bottom made of AISI 430.

According to one aspect, the inductance of the coil is between 45 micro-Henries and 60 micro-Henries when the equivalent resistance is between 8 and 15 ohms at the working frequency.

According to one aspect, the coil includes wire forming a plurality of windings and having a cross-sectional area between 1.8 square millimeters and 3.0 square millimeters.

According to one aspect, the coil is spaced below the cooking surface by at most 7 millimeters.

According to one aspect, the coil is part of an induction coil assembly that includes a ferrite layer spaced from and below the coil, wherein the ferrite layer includes a plurality of ferrites having a height in a direction orthogonal to the cooking surface of between 3 millimeters and 5 millimeters.

According to one aspect, the induction coil assembly has a stack height in a direction orthogonal to the cooking surface between a bottom surface of the induction coil assembly and a top surface of the of the induction coil assembly between 7 millimeters and 10 millimeters.

According to yet another aspect of the present disclosure, an induction cooktop includes a cooking surface operable to support cookware and a resonant circuit having a resonant frequency in the range of 40 kHz to 60 kHz. The resonant circuit includes a capacitor having capacitance of between 0.1 micro-Farads and 0.6 micro-Farads and a coil disposed under the cooking surface and configured to operate at a working frequency of between 50 kHz and 150 kHz. The resonant circuit is configured to have an equivalent alternating-current (AC) resistance of between 8 ohms and 15 ohms at the working frequency when cookware overlays the coil and includes a bottom made of AISI 430. An induction control circuit is configured to power the resonant circuit at the working frequency via a full-bridge inverter.

According to one aspect, the inductance of the coil is between 45 micro-Henries and 60 micro-Henries when the equivalent resistance is between 8 and 15 ohms at the working frequency.

According to one aspect, an induction coil assembly for a cooktop includes a coil disposed on a central axis and including wire forming an outer coil portion, and inner coil portion spaced from the outer coil portion, and an intermediate coil portion spaced from and between the outer coil and the inner coil, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the first ferrites have a first length of double a second length of the second ferrites and a common width to a width of the second ferrites, and wherein one second ferrite interposes each of a pair of adjacent first ferrites.

According to one aspect, a radial spacing between the outer coil portion and the intermediate coil portion is substantially equal to a radial spacing between the inner coil portion and the intermediate coil portion.

According to one aspect, each of the coil portions includes between 7 and 9 windings.

According to one aspect, the induction coil assembly includes a second thermally resistant layer overlaying the coil and disposed between the coil and a glass layer of the cooktop.

According to one aspect, the induction coil assembly is configured to engage an underside of an insulative layer that supports cookware for the cooktop, wherein the induction coil assembly has a height orthogonal to the insulative layer of between 7 millimeters and 10 millimeters.

According to one aspect, the height is less than 9 millimeters.

According to one aspect, the wire has a cross-sectional area of between 5 square millimeters and 6 square millimeters.

According to one aspect, the wire has a wire width orthogonal to the central axis of between 2 millimeters and 3 millimeters.

According to one aspect, the wire has a wire height parallel to the central axis of between 2 millimeters and 3 millimeters.

According to one aspect, the ferrite layer includes 12 ferrite bars evenly distributed about the central axis with an angular spacing between each adjacent pair of ferrite bars of 30 degrees.

According to one aspect, the coil includes a bottom side having a coil footprint area and the ferrite bars have a target area facing the coil footprint area, wherein the target area is between 30% and 40% of the coil footprint area.

According to one aspect, an induction coil assembly for a cooktop includes a coil disposed on a central axis and including wire forming an outer coil portion, and inner coil portion spaced from the outer coil portion, and an intermediate coil portion spaced from and between the outer coil and the inner coil, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the first ferrites have a first length of double a second length of the second ferrites and a common width to a width of the second ferrites, and wherein one second ferrite interposes each of a pair of adjacent first ferrites, wherein a radial spacing between the outer coil portion and the intermediate coil portion is substantially equal to a radial spacing between the inner coil portion and the intermediate coil portion.

According to one aspect, the wire has a cross-sectional area of between 5 square millimeters and 6 square millimeters.

According to one aspect, the wire has a wire width orthogonal to the central axis of between 2 millimeters and 3 millimeters.

According to one aspect, the wire has a wire height parallel to the central axis of between 2 millimeters and 3 millimeters.

According to one aspect, the ferrite layer includes 12 ferrite bars evenly distributed about the central axis with an angular spacing between each adjacent pair of ferrite bars of 30 degrees.

According to one aspect, the coil includes a bottom side having a coil footprint area and the ferrite bars have a target area facing the coil footprint area, wherein the target area is between 30% and 40% of the coil footprint area.

According to one aspect, an induction coil assembly for a cooktop includes a coil disposed on a central axis and including wire forming an outer coil portion, and inner coil portion spaced from the outer coil portion, and an intermediate coil portion spaced from and between the outer coil and the inner coil, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the first ferrites have a first length of double a second length of the second ferrites and a common width to a width of the second ferrites, wherein one second ferrite interposes each of a pair of adjacent first ferrites, wherein a radial spacing between the outer coil portion and the intermediate coil portion is substantially equal to a radial spacing between the inner coil portion and the intermediate coil portion, and wherein the induction coil assembly has a height parallel to the central axis of between 7 millimeters and 10 millimeters.

According to one aspect, the wire has a cross-sectional area of between 5 square and 6 square millimeters.

According to one aspect, the wire has a wire width orthogonal to the central axis of between 2 millimeters and 3 millimeters.

According to one aspect, an induction coil assembly for a cooktop includes a coil portion spaced from the outer coil portion by a gap, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the second ferrites have a second length of 60% a first length of the first ferrites and a common width to a width of the first ferrites, and wherein one second ferrite interposes each of a pair of adjacent first ferrites.

According to one aspect, the gap is approximately 33% of a sum of a width of the outer coil portion and a width of the inner coil portion.

According to one aspect, the outer coil portion and the inner coil portion have a common number of windings.

According to one aspect, the outer coil portion and the inner coil portion each include 12 windings.

According to one aspect, a second thermally resistant layer overlays the coil and is disposed between the coil and a glass layer of the cooktop.

According to one aspect, the induction coil assembly is configured to engage an underside of an insulative layer that supports cookware for the cooktop, wherein the induction coil assembly has a height orthogonal to the insulative layer of between 7 millimeters and 10 millimeters.

According to one aspect, the height is less than 8 millimeters.

According to one aspect, the wire has a cross-sectional area of between 5 square millimeters and 6 square millimeters.

According to one aspect, the wire has a wire width orthogonal to the central axis of between 2 millimeters and 3 millimeters.

According to one aspect, the wire has a wire height parallel to the central axis of between 2 millimeters and 3 millimeters.

According to one aspect, the ferrite layer includes 12 ferrite bars evenly distributed about the central axis with an angular spacing between each adjacent pair of ferrite bars of 30 degrees.

According to one aspect, the coil includes a bottom side having a coil footprint area and the ferrite bars have a target area facing the coil footprint area, wherein the target area is between 35% and 45% of the coil footprint area.

According to one aspect, an induction coil assembly for a cooktop includes a coil disposed on a central axis and including wire forming an outer coil portion and an inner coil portion spaced from the outer coil portion by a gap approximately 33% of a sum of a width of the outer coil portion and a width of the inner coil portion, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the second ferrites have a second length of 60% a first length of the first ferrites and a common width to a width of the first ferrites, and wherein one second ferrite interposes each of a pair of adjacent first ferrites.

According to one aspect, the wire has a cross-sectional area of between 5 square millimeters and 6 square millimeters.

According to one aspect, the wire has a wire width orthogonal to the central axis of between 2 millimeters and 3 millimeters.

According to one aspect, the wire has a wire height parallel to the central axis of between 2 millimeters and 3 millimeters.

According to one aspect, the ferrite layer includes 12 ferrite bars evenly distributed about the central axis with an angular spacing between each adjacent pair of ferrite bars of 30 degrees.

According to one aspect, the coil includes a bottom side having a coil footprint area and the ferrite bars have a target area facing the coil footprint area, wherein the target area is between 35% and 45% of the coil footprint area.

According to one aspect, an induction coil assembly for a cooktop includes a coil portion spaced from the outer coil portion by a gap approximately 33% of a sum of a width of the outer coil portion and a width of the inner coil portion, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the second ferrites have a second length of 60% a first length of the first ferrites and a common width to a width of the first ferrites, and wherein one second ferrite interposes each of a pair of adjacent first ferrites, wherein the outer coil portion and the inner coil portion have a common number of windings.

According to one aspect, the outer coil portion and the inner coil portion each include 12 windings.

According to one aspect, an induction coil assembly for a cooktop includes a coil disposed on a central axis and including wire forming an outer coil portion and an inner coil portion spaced from the outer coil portion by a gap, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the second ferrites have a second length of between 40% and 50% of a first length of the first ferrites and a common width to a width of the first ferrites, and wherein one second ferrite interposes each of a pair of adjacent first ferrites.

According to one aspect, the gap is approximately 33% of a sum of a width of the outer coil portion and a width of the inner coil portion.

According to one aspect, the inner coil portion has less windings than a number of windings of the outer coil portion.

According to one aspect, the outer coil portion includes 13 windings and the inner coil portion includes 11 windings.

According to one aspect, the induction coil assembly includes a second thermally resistant layer overlaying the coil and disposed between the coil and a glass layer of the cooktop.

According to one aspect, the induction coil assembly is configured to engage an underside of an insulative layer that supports cookware for the cooktop, wherein the induction coil assembly has a height orthogonal to the insulative layer of between 7 millimeters and 9 millimeters.

According to one aspect, the height is equal to 8 millimeters.

According to one aspect, wherein the wire has a cross-sectional area of less than 5 square millimeters.

According to one aspect, the wire has a wire width orthogonal to the central axis of between 2 millimeters and 3 millimeters.

According to one aspect, the wire has a wire height parallel to the central axis of between 2 millimeters and 3 millimeters.

According to one aspect, the ferrite layer includes 12 ferrite bars evenly distributed about the central axis with an angular spacing between each adjacent pair of ferrite bars of 30 degrees.

According to one aspect, the coil includes a bottom side having a coil footprint area and the ferrite bars have a target area facing the coil footprint area, wherein the target area about 50% of the coil footprint area.

According to one aspect, an induction coil assembly for a cooktop includes a coil disposed on a central axis and including wire forming an outer coil portion and an inner coil portion spaced from the outer coil portion by a gap approximately 33% of a sum of a width of the outer coil portion and a width of the inner coil portion, a first thermally resistant layer disposed under the coil and supporting the coil, the first thermally resistant layer extending radially outwardly beyond the outer coil portion, a ferrite layer disposed under the first thermally resistant layer and including a plurality of first ferrites and a plurality of second ferrites each distributed about the central axis, wherein the second ferrites have a second length of between 40% and 50% of a first length of the first ferrites and a common width to a width of the first ferrites, and wherein one second ferrite interposes each of a pair of adjacent first ferrites.

According to one aspect, the wire has a cross-sectional area of less than 5 square millimeters.

According to one aspect, the wire has a wire width orthogonal to the central axis of between 2 millimeters and 3 millimeters.

According to one aspect, the wire has a wire height parallel to the central axis of between 2 millimeters and 3 millimeters.

According to one aspect, the ferrite layer includes 12 ferrite bars evenly distributed about the central axis with an angular spacing between each adjacent pair of ferrite bars of 30 degrees.

According to one aspect, the coil includes a bottom side having a coil footprint area and the ferrite bars have a target area facing the coil footprint area, wherein the target area is about 50% of the coil footprint area.

According to one aspect, an induction coil assembly for a cooktop includes a coil disposed on a central axis and including wire forming an outer coil portion and an inner coil portion spaced from the outer coil portion by a gap approximately 33% of a sum of a width of the outer coil portion and a width of the inner coil portion, a first thermally resistant layer disposed under the coil and supporting the coil, the first thermally resistant layer extending radially outwardly beyond the outer coil portion, and a ferrite layer disposed under the first thermally resistant layer and including a plurality of first ferrites and a plurality of second ferrites each distributed about the central axis, wherein the second ferrites have a second length of between 40% and % 50 a first length of the first ferrites and a common width to a width of the first ferrites, and wherein one second ferrite interposes each of a pair of adjacent first ferrites, wherein the inner coil portion has less windings than a number of windings of the outer coil portion.

According to one aspect, the outer coil portion includes 13 windings and the inner coil portion includes 11 windings.

According to one aspect, an induction coil assembly for a cooktop includes a coil disposed on a central axis and including wire forming a plurality of windings; a first thermally resistant layer disposed under the coil and supporting the coil, the first thermally resistant layer extending radially outwardly beyond the outer coil portion; and a ferrite layer disposed under the first thermally resistant layer and including a plurality of ferrites distributed about the central axis, wherein a width of each ferrite is between 30% and 40% of a length of each ferrite.

According to one aspect, the plurality of windings form a single coil portion with abutting windings.

According to one aspect, the induction coil assembly includes a second thermally resistant layer overlaying the coil and disposed between the coil and a glass layer of the cooktop.

According to one aspect, the induction coil assembly is configured to engage an underside of an insulative layer that supports cookware for the cooktop, wherein the induction coil assembly has a height orthogonal to the insulative layer of between 7 millimeters and 9 millimeters.

According to one aspect, the height is less than 8 millimeters.

According to one aspect, the wire has a cross-sectional area of less than 4 square millimeters.

According to one aspect, the wire has a wire width orthogonal to the central axis of between 2 millimeters and 3 millimeters.

According to one aspect, the wire has a wire height parallel to the central axis of less than 2 millimeters.

According to one aspect, the ferrite layer includes 6 ferrite bars evenly distributed about the central axis with an angular spacing between each adjacent pair of ferrite bars of 60 degrees.

According to one aspect, the coil includes a bottom side having a coil footprint area and the ferrite bars have a target area facing the coil footprint area, wherein the target area is between 30% and 40% of the coil footprint area.

According to one aspect, an induction coil assembly for a cooktop includes a coil disposed on a central axis and including wire forming a plurality of windings forming a single coil portion with abutting windings; a first thermally resistant layer disposed under the coil and supporting the coil, the first thermally resistant layer extending radially outwardly beyond the outer coil portion; and a ferrite layer disposed under the first thermally resistant layer and including a plurality of first ferrites and a plurality of second ferrites each distributed about the central axis, wherein the second ferrites have a second length of between 40% and 50% of a first length of the first ferrites and a common width to a width of the first ferrites, and wherein one second ferrite interposes each of a pair of adjacent first ferrites.

According to one aspect, the wire has a cross-sectional area of less than 4 square millimeters.

According to one aspect, the wire has a wire width orthogonal to the central axis of between 2 millimeters and 3 millimeters.

According to one aspect, the wire has a wire height parallel to the central axis of less than 2 millimeters.

According to one aspect, the ferrite layer includes 6 ferrite bars evenly distributed about the central axis with an angular spacing between each adjacent pair of ferrite bars of 60 degrees.

According to one aspect, the coil includes a bottom side having a coil footprint area and the ferrite bars have a target area facing the coil footprint area, wherein the target area is between 30% and 40% of the coil footprint area.

According to one aspect, an induction coil assembly for a cooktop includes a coil disposed on a central axis and including wire forming a plurality of windings forming a single coil portion with abutting windings; a first thermally resistant layer disposed under the coil and supporting the coil, the first thermally resistant layer extending radially outwardly beyond the outer coil portion; and a ferrite layer disposed under the first thermally resistant layer and including a plurality of first ferrites and a plurality of second ferrites each distributed about the central axis, wherein the second ferrites have a second length of between 40% and 50% of a first length of the first ferrites and a common width to a width of the first ferrites, and wherein one second ferrite interposes each of a pair of adjacent first ferrites, wherein the coil includes no other coil portions other than the single coil portion.

According to one aspect, the coil includes 26 windings.

According to one aspect, an induction coil assembly for a cooktop includes a coil disposed on a central axis and including wire forming an outer coil portion and an inner coil portion spaced from the outer coil portion by a gap; a first thermally resistant layer disposed under the coil and supporting the coil, the first thermally resistant layer extending radially outwardly beyond the outer coil portion; and a ferrite layer disposed under the first thermally resistant layer and including a plurality of first ferrites and a plurality of second ferrites each distributed about the central axis, the gap has a first depth along sides of the coil and a second depth along a front and a rear of the coil, wherein the first depth is approximately half of the second depth.

According to one aspect, the coil is rectangular.

According to one aspect, the outer coil portion and the inner coil portion have approximately the same number of windings.

According to one aspect, the outer coil portion and the inner coil portion each include at least 11 windings.

According to one aspect, the induction coil assembly includes a second thermally resistant layer overlaying the coil and disposed between the coil and a glass layer of the cooktop.

According to one aspect, the induction coil assembly is configured to engage an underside of an insulative layer that supports cookware for the cooktop, wherein the induction coil assembly has a height orthogonal to the insulative layer of between 7 millimeters and 10 millimeters.

According to one aspect, the height is less than 9 millimeters.

According to one aspect, the wire has a wire height parallel to the central axis of between 2 millimeters and 3 millimeters.

According to one aspect, the ferrite layer includes outer ferrites and inner ferrites, wherein all of the inner ferrites are disposed closer to the central axis than the outer ferrites.

According to one aspect, the inner portion overlays the inner ferrites and the outer portion overlays the outer ferrites. According to one aspect, the outer ferrites include corner ferrites and intermediate ferrites interposing the corner ferrites.

According to one aspect, the intermediate ferrites are spaced from one another by between 10 millimeters and 20 millimeters.

According to one aspect, an induction coil assembly for a cooktop includes a coil disposed on a central axis and including wire forming an outer coil portion and an inner coil portion spaced from the outer coil portion by a gap, wherein the coil is rectangular; a first thermally resistant layer disposed under the coil and supporting the coil, the first thermally resistant layer extending radially outwardly beyond the outer coil portion; and a ferrite layer disposed under the first thermally resistant layer and including a plurality of first ferrites and a plurality of second ferrites each distributed about the central axis, the gap has a first depth along sides of the coil and a second depth along a front and a rear of the coil, wherein the first depth is approximately half of the second depth, wherein the ferrite layer includes outer ferrites and inner ferrites, wherein all of the inner ferrites are disposed closer to the central axis than the outer ferrites.

According to one aspect, the outer coil portion and the inner coil portion have approximately the same number of windings.

According to one aspect, the outer coil portion and the inner coil portion each include at least 11 windings.

According to one aspect, the induction coil assembly includes a second thermally resistant layer overlaying the coil and disposed between the coil and a glass layer of the cooktop.

According to one aspect, the inner portion overlays the inner ferrites and the outer portion overlays the outer ferrites.

According to one aspect, the outer ferrites include corner ferrites and intermediate ferrites interposing the corner ferrites.

According to one aspect, the intermediate ferrites are spaced from one another by between 10 millimeters and 20 millimeters.

According to one aspect, an induction coil assembly for a cooktop includes a coil portion spaced from the outer coil portion by a gap, wherein the coil is rectangular; a first thermally resistant layer disposed under the coil and supporting the coil, the first thermally resistant layer extending radially outwardly beyond the outer coil portion; and a ferrite layer disposed under the first thermally resistant layer and including a plurality of first ferrites and a plurality of second ferrites each distributed about the central axis, the gap has a first depth along sides of the coil and a second depth along a front and a rear of the coil, wherein the first depth is approximately half of the second depth, wherein the ferrite layer includes outer ferrites and inner ferrites, wherein all of the inner ferrites are disposed closer to the central axis than the outer ferrites, wherein the inner portion overlays the inner ferrites and the outer portion overlays the outer ferrites.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An induction cooktop, comprising:
a cooking surface operable to support cookware;
a resonant circuit having a resonant frequency in the range of 40 kHz to 60 kHz and including:
a capacitor having capacitance of between 0.1 micro-Farads and 0.6 micro-Farads; and
a coil disposed under the cooking surface and configured to operate at a working frequency of between 50 kHz and 150 kHz; and
an induction control circuit configured to power the resonant circuit at the working frequency.

2. The induction cooktop of claim 1, wherein the induction control circuit includes a full-bridge inverter that controls current through the coil.

3. The induction cooktop of claim 1, wherein the resonant circuit is configured to have an equivalent alternating-current (AC) resistance of between 8 ohms and 15 ohms at the working frequency when cookware overlays the coil and includes a bottom made of AISI 430.

4. The induction cooktop of claim 3, wherein the inductance of the coil is between 45 micro-Henries and 60 micro-Henries when the equivalent resistance is between 8 and 15 ohms at the working frequency.

5. The induction cooktop of claim 1, wherein the coil includes wire forming a plurality of windings and having a height in a direction orthogonal to the cooking surface of between 1.5 millimeters and 2.5 millimeters.

6. The induction cooktop of claim 5, wherein the wire has a width in a direction parallel to the cooking surface of between 1.5 millimeters and 3 millimeters.

7. The induction cooktop of claim 5, wherein a cross-sectional area of the wire is between 1.8 square millimeters and 3.0 square millimeters.

8. The induction cooktop of claim 7, wherein a total weight of the coil is less than 300 grams.

9. The induction cooktop of claim 1, wherein the coil is spaced below the cooking surface by at most 7 millimeters.

10. The induction cooktop of claim 1, wherein the coil is part of an induction coil assembly that includes a ferrite layer spaced from and below the coil, wherein the ferrite layer includes a plurality of ferrites having a height in a direction orthogonal to the cooking surface of between 3 millimeters and 5 millimeters.

11. The induction cooktop of claim 10, wherein the induction coil assembly has a stack height in a direction orthogonal to the cooking surface between a bottom surface of the induction coil assembly and a top surface of the of the induction coil assembly between 7 millimeters and 10 millimeters.

12. An induction coil assembly for an induction cooktop, comprising:
a cooking surface operable to support cookware;
a resonant circuit having a resonant frequency in the range of 40 kHz to 60 kHz and including:
a capacitor having capacitance of between 0.1 uF and 0.6 uF; and
a coil disposed under the cooking surface and configured to operate at a working frequency of between 50 kHz and 150 kHz; and
an induction control circuit configured to power the resonant circuit at the working frequency via a full-bridge inverter.

13. The induction cooktop of claim 12, wherein the resonant circuit is configured to have an equivalent alternating-current (AC) resistance of between 8 ohms and 15 ohms at the working frequency when cookware overlays the coil and includes a bottom made of AISI 430.

14. The induction cooktop of claim 13, wherein the inductance of the coil is between 45 micro-Henries- and 60 micro-Henries when the equivalent resistance is between 8 and 15 ohms at the working frequency.

15. The induction cooktop of claim 12, wherein the coil includes wire forming a plurality of windings and having a cross-sectional area between 1.8 square millimeters and 3.0 square millimeters.

16. The induction cooktop of claim 12, wherein the coil is spaced below the cooking surface by at most 7 millimeters.

17. The induction cooktop of claim 12, wherein the coil is part of an induction coil assembly that includes a ferrite layer spaced from and below the coil, wherein the ferrite layer includes a plurality of ferrites having a height in a direction orthogonal to the cooking surface of between 3 millimeters and 5 millimeters.

18. The induction cooktop of claim 17, wherein the induction coil assembly has a stack height in a direction orthogonal to the cooking surface between a bottom surface of the induction coil assembly and a top surface of the of the induction coil assembly between 7 millimeters and 10 millimeters.

19. An induction cooktop, comprising:
a cooking surface operable to support cookware;
a resonant circuit having a resonant frequency in the range of 40 kHz to 60 kHz and including:
a capacitor having capacitance of between 0.1 micro-Farads and 0.6 micro-Farads; and
a coil disposed under the cooking surface and configured to operate at a working frequency of between 50 kHz and 150 kHz, wherein the resonant circuit is configured to have an equivalent alternating-current (AC) resistance of between 8 ohms and 15 ohms at the working frequency when cookware overlays the coil and includes a bottom made of AISI 430; and
an induction control circuit configured to power the resonant circuit at the working frequency via a full-bridge inverter.

20. The induction cooktop of claim 19, wherein the inductance of the coil is between 45 micro-Henries and 60 micro-Henries when the equivalent resistance is between 8 and 15 ohms at the working frequency.
